(19) United States
(12) Patent Application Publication
(10) Pub. No.: US 2016/0342741 A1
(43) Pub. Date: Nov. 24, 2016

(54) SERVICE-ORIENTED, INTEGRATIVE NETWORKING PLATFORM, SYSTEM AND METHOD

(71) Applicants: Kingsley Chin, Fort Lauderdale, FL (US); Michael Amaru, Reading, MA (US); Aditya Humad, Cambridge, MA (US); Paul Spiedel, Beverly, MA (US)

(72) Inventors: Kingsley Chin, Fort Lauderdale, FL (US); Michael Amaru, Reading, MA (US); Aditya Humad, Cambridge, MA (US); Paul Spiedel, Beverly, MA (US)

(21) Appl. No.: 15/106,604

(22) PCT Filed: Dec. 22, 2014
(86) PCT No.: PCT/US14/71955

§ 371 Date: Jun. 20, 2016

Related U.S. Application Data
(60) Provisional application No. 61/919,674, filed on Dec. 20, 2013.
(60) Provisional application No. 61/919,568, filed on Dec. 20, 2013.
(60) Provisional application No. 62/023,608, filed on Jul. 11, 2014.

(51) Int. Cl. G06F 19/00; H04L 29/08; G06Q 30/02; G06Q 10/10

(52) U.S. Cl. CPC G06F 19/322; G06Q 10/1095; H04L 67/306; G06Q 30/0269

(57) ABSTRACT

In accordance with aspects of the present invention, provided is service-oriented, integrative networking system where a user (e.g., a patient) can have a single profile, single login, meaningful connections through medicine, since every person is a patient at some point in their life and has to see a doctor. A user's profile can be a portal to anything on Internet, which allows a user to select connections, have its medical records shared seamlessly with its doctors, and a user can track its appointments, vaccinations, and so on.

### REFERENCE TO RELATED APPLICATIONS

The present invention claims priority under 35 USC 119(e) to U.S. provisional patent application 61/919,568 entitled SERVICE-ORIENTED, INTEGRATIVE NETWORKING PLATFORM, SYSTEM AND METHOD, filed Dec. 20, 2013; U.S. provisional patent application 61/919,674 entitled SERVICE-ORIENTED, INTEGRATIVE NETWORKING PLATFORM, SYSTEM AND METHOD, filed Dec. 20, 2013; and U.S. provisional patent application 62/023,608 entitled SERVICE-ORIENTED, INTEGRATIVE NETWORKING PLATFORM, SYSTEM AND METHOD, filed Jul. 11, 2014, each of which is incorporated herein by reference in its entirety.

### FIELD OF INTEREST

The present inventive concepts relate to the field of computer-based networking platforms, systems and methods, and more particularly to the field of service-oriented computer based platforms, systems and methods.

### SUMMARY

Provided is a service-oriented, integrative networking system that recognizes, for example in a medical context, that every person needs to visit a doctor at some point and that most people maintain some connection to healthcare services annually. The Internet has made it easier for us to satisfy our need for health and wellness information and sites such as WebMD have capitalized on this need. Consumers are becoming increasingly aware and informed of their health, with 138 million unique users visiting WebMD each month. This indicates the potential for the system to similarly acquire users driven to connect with our physicians and healthcare services. The system also recognizes that most people have multiple usernames and passwords, each for a specific Internet company or service and that this can be burdensome.

Because everyone should see a healthcare provider each year for good health, the system can be configured to provide each user with a personalized profile page to maintain connections with their doctors, friends, and professionals via one username and password to access the system marketplace with its directory of Internet services to join, preferably for free. In some embodiments, the system can accomplish access to a user's multiple Internet services or web page user names and passwords by (1) requesting that information, (2) remaining logged in at the system webpage, or (3) by other manners.

Social networking giants, such as Facebook or LinkedIn, are predicated on their members having many connections to other members. However, they lack meaningful connections, useful categorizations of the connections, or useful needed content so users access these sites and maintain profiles by choice, not because they feel the need. There is an opportunity for members, using one embodiment, to have an improved profile page with better management and categorization of their connections and have easy access to their Internet services through one username and password.

While the present embodiment is focused on healthcare professionals to build the initial marketplace, anyone can join as they will need to see a doctor or use other Internet services in other embodiments. In various embodiments, Internet service companies can be populated on the system directory, e.g., for free. And in various embodiments, users could join, e.g., also for free, and utilize any of the related business services listed on the system to search, rate, review, and book appointments with their doctors or other service providers and, optionally, link directly to their favorite online businesses in the system's directory—without the need to leave their profile or use a search engine, such as Google, for example. In alternative embodiments, a user does not have to complete a profile or create different levels of information requested or captured.

In various embodiments, each member defines its profile for other potential users to connect, but only with permission and with the ability to limit connections to specific categories of connections, and not to the entire list of someone's connections. A user's connections per category can be advertised to the users themselves or to their connections, if permitted, or to potential connections, so that such potential connections can view their interests prior to contacting them (for example, total connections=100, Investors=40, Friends=24, Doctors=30 etc., as categories). Users could decide to link to certain categories of another member, if approved, based on their interest.

In various embodiment, one of the key features of the system-provided experience is in qualifying a request for a connection based on the interest (friend, co-worker, professional, doctor etc.) and what a user/member can be contacted for (investment, jobs, reference, date etc.). In the present system every person, doctor and business interested in being a service-oriented, integrative networking system member, wherever they are in the world, can access their healthcare services, providers or other services and/or providers and be connected in a meaningful manner to others based on user needs and preferences including healthcare and non-healthcare services. Revenues can, for example, be derived from subscription services for businesses and advertisements, and/or different levels of business or user memberships.

There are over 850,000 licensed physicians and over 100,000 physicians-in-training in the US according to the Journal of American Medical Association. Profiles can be created in the system for all physicians and the physicians can subsequently be asked to activate their profiles. The benefits to doctors who activate their profiles can be demonstrated to energize physician participation through social media, viral marketing through existing relationships, partnerships and endorsements from medical societies, such as American Academy of Orthopedic Surgeons (AAOS), American Academy of Neurosurgeons (AANS), National Medical Association (NMA), American Medical Association (AMA), and North American Spine Society (NASS), as examples. Once doctors are activated, patients can come to manage their healthcare needs and, while a user is logged in s/he can be connected with friends, professionals, and access other internet services without needing separate usernames and passwords and profile pages. In various embodiments, the system will provide links to these services via a website/browser interface, for example.

The service-oriented, integrative networking system addresses the key issues laced by most social media sites:
Getting people to the website (e.g., through periodic medical checkups or acute care events since users care more about their health needs, future medical care or, as a caretaker for a family member or friend)
Getting people to stay on the website for longer periods of time (e.g., simple password, one portal to physicians, business services, and meaningful content and connections)
Getting people to keep revisiting the website (e.g., medical appointment, medication, vaccination tracker, medical information and profile, establish connections)

The service-oriented, integrative networking system can include an existing database of, for example, approximately 100,000 surgeons initially and a web interface with healthcare service providers complementary listed on its webpage, such as Marketing4Docs that provides marketing services to physicians or healthcare providers, SurgeonSelector that allows patients to book appointments with surgeons, and DocM connecting patients to physicians, and SurgeonOpinion providing patients with a large pool of surgeons within the network for medical opinions. As new members come on, they can list services in the system's directory and within their own profile directory preferences, so the directory list can grow automatically. Also lists of service can be auto-populated, based on search conducted in the background (not visible to user). Suggest companies based on user preferences or user tracked clicks.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a computer architecture showing an example of a service-oriented, integrative networking system, in accordance with aspects of the present invention;

FIG. 2 is a functional block diagram of an embodiment of a service-oriented, integrative networking system, in accordance with aspects of the present invention;

FIG. 3 is a flowchart of an embodiment of a method of medical records, in the system of FIGS. 1 and 2, in accordance with aspects of the present invention;

FIG. 4 is a flowchart of an embodiment of a detailed method of interaction and processing accomplished using the system of FIGS. 1 and 2, in accordance with aspects of the present invention;

FIGS. 5-9 are embodiments of display screens that can be generated by the system of FIGS. 1 and 2, in accordance with aspects of the present invention;

FIGS. 10-13 are block diagrams depicting example embodiments of a service-oriented, integrative networking system, in accordance with aspects of the present invention; and

FIG. 14 is an embodiment where the service-oriented, integrative networking system (part 14-A) of the present invention is integrated into a larger system, network, and method, where the service-oriented, integrative networking system is used as a hub, integrator, portal and/or access point to a plurality of 3rd party systems (FIG. 14 parts B, C, D, E, F, G, H, I and J) that, while not essential, can all be within or related to a specified field, e.g., the medical field in this example, in accordance with aspects of the present invention

FIG. 15 is an example embodiment of a physician's profile page;

FIG. 16 is an example flow chart of a process by which a patient may receive assistance in accordance with principles of inventive concepts;

FIGS. 17A-17F are example screenshots related to a process by which a patient may receive assistance in accordance with principles of inventive concepts;

FIG. 18 is an example embodiment of a patient's profile page in accordance with principles of inventive concepts;

FIG. 19 is an example embodiment of a patient/provider/payment flow in accordance with principles of inventive concepts;

FIG. 20 is an example embodiment of a mobile electronic device that incorporates features of a patient/physician interface in accordance with principles of inventive concepts; and

FIG. 21 illustrates example embodiments of physician and patient interfaces in accordance with principles of inventive concepts.

### DETAILED DESCRIPTION OF PREFERRED EMBODIMENTS

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

In accordance with aspects of the present invention, provided is a service-oriented, integrative networking system, method and platform. In the representative embodiment described herein, the inventive concepts are described in the medical, e.g., doctor (as a service provider)—patient (as a consumer) context. Those skilled in the art will recognize, however, that the inventive concepts, and various aspects thereof, can be provided in any number of contexts, or mixed contexts, and are not necessarily limited to the medical or healthcare context.

The present invention, recognizes the generally accepted requirement for every person to see a doctor (or other healthcare provider) with some regularity, although that may change over time based on health status and the need for treatment for a particular condition, for a birth, diagnosis, procedures, or annually for routine check-ups. Every person has a medical record stored with each healthcare provider they see mostly in paper form that is not easily accessible or transferable. With the proliferation of electronic medical records (EMR) systems, there is an opportunity for people to have online ownership and management of their medical records and to build connections with their healthcare providers online, which goes well beyond what is provided by EMR systems.

In accordance with the present invention, there is provide an integrative gateway with a single password and username to connect with his/her providers and access internet services in this one marketplace. Social networking giants, such as Facebook or LinkedIn, are predicated on having as many connections to members as you can, but there is no useful categorization, meaningful connections or content or a need that requires them to access these sites, unlike with accessing health connections through a service-oriented, integrative networking system in accordance with the present invention. Such a system provides a new and unique opportunity for connected members to see their doctors, for example, and to connect with their favorite online sites, while they are logged into a personal profile page. Everyone is a patient at some point, so the group for potential members are everyone. Users can utilize any of the related business services listed on the service-oriented, integrative networking system to search, rate, review, and book appointments with their doctors, and other medical professionals, and link directly to online businesses without the need to leave their profile or search in Google.

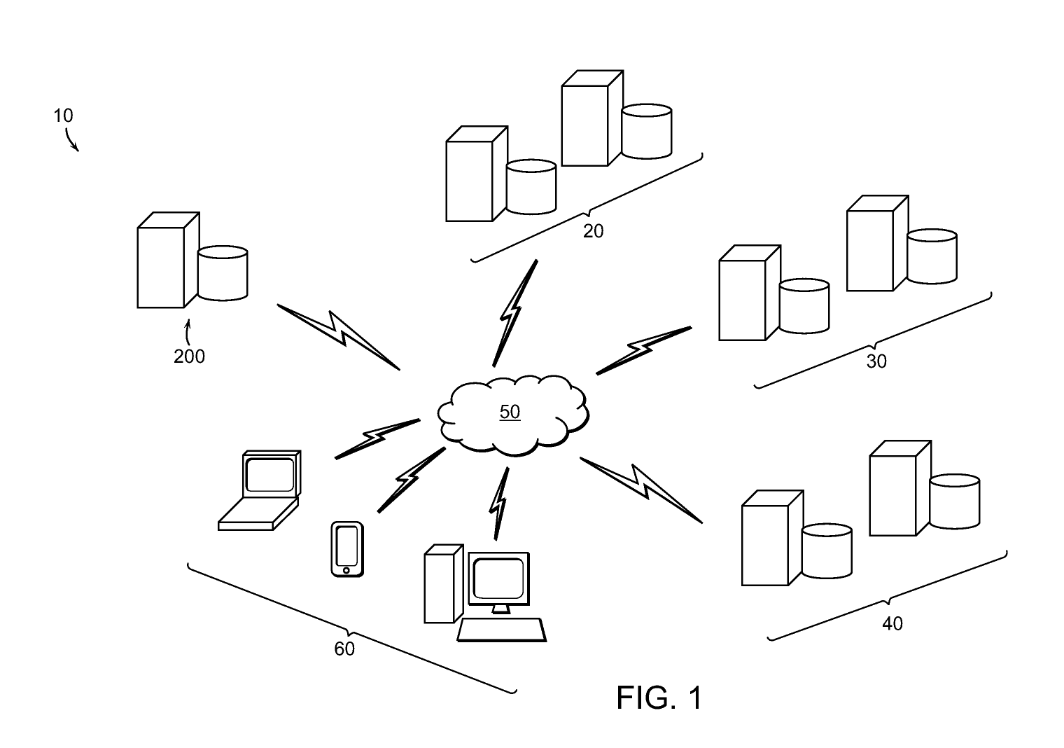

FIG. 1 is a computer architecture 10 showing an example of a service-oriented, integrative networking system 200 in accordance with aspects of the present invention. In this embodiment, service-oriented, integrative networking system 200 includes one or more computer processors (e.g., servers) coupled to one or more computer and/or data storage systems, devices, and or media, as variously shown. Service-oriented, integrative networking system 200 is configured to generate a computer interface, e.g., a browser or window interface, that enables a user to enter a network that combines social and professional members and links, e.g., in the medical field. The interface can allow such user to establish and maintain at least one profile, link to friends, family, colleagues, and healthcare and medical professionals, and access other systems or networks, preferably without the need for additional logins for such access—at least for some external systems, if not all. In several regards, system 200 provides functioning and a user interface that is much more efficient than possible with prior systems.

That is, in various embodiments, service-oriented, integrative networking system 200 is representative of a system that can include the core technology and functionality useful for establishing an on-line, networked community including service (and/or goods) providers and consumers, available functions, and a portal to external systems. That is, system 200 is configured to access and, potentially, be accessible by a plurality of other types of systems and devices, via at least one network 50, generally referred to here as third (3^{rd}) party systems. Network 50 represents a variety of types of wired and/or wireless networks, e.g., the Internet, intranet, virtual private network (VPN), cellular network, satellite network, cable network, and so on, and combinations thereof.

In various embodiments, a user could store login information for a set of third party systems in the service-oriented, integrative networking system 200 and upon login to the service-oriented, integrative networking system 200, the service-oriented, integrative networking system could automatically or with user prompt login to such 3rd party systems without requiring user input of the login information for such 3^{rd} party systems. In various embodiments, therefore, the user can associate specific 3^{rd} party systems with its profile in the service-oriented, integrative networking system 200, and can specify those 3^{rd} party systems for which automatic login will be provided. Automatic login can require (1) no further user input, only logging into the service-oriented, integrative networking system 200, (2) only user selection of the 3rd party system from within the interface of the service-oriented, integrative networking system 200, and/or (3) user entry of a secondary authentication input, e.g., answer a security question, before the service-oriented, integrative networking system 200 logs into to the corresponding 3^{rd} party system. Therefore, in various embodiments, different 3^{rd} party systems can have different authentication requirements through the service-oriented, integrative networking system 200. Preferably, the login information and security questions and answers are securely maintained, which could include encryption.

As an example, when logging into the service-oriented, integrative networking system 200, the user could also be automatically logged into the Facebook, LinkedIn, and Gmail, but not a healthcare system having access to the user's medical records. Such access to the medical records system could require, once logged into the service-oriented, integrative networking system 200, a user selection of a tab or icon (or other prompt) representing such 3rd party system—to initiate the automatic login, wherein the user does not have to enter the login information for the 3^{rd} party system. The service-oriented, integrative networking system 200 would then electronically provide such login information in response to the user's prompt. However, the capability could also be provided to solicit a further user input, e.g., answering a security questions (e.g., What is your mother's maiden name?), as a secondary authentication input. This input is used only by the service-oriented, integrative networking system 200 to enable its automatic login capability for the 3^{rd} party system, which then transmits the login information to the 3^{rd} party system without the need for the user to enter the login information for the 3^{rd} party system.

Such 3^{rd} party systems could include healthcare information systems 20, e.g., electronic medical record (EMR) systems, medical practice listings, medical provider (e.g., doctor) listings, healthcare provider systems, and so forth. With respect to EMR systems, the service-oriented, integrative networking system 200 can serve as a portal into such systems for accessing the user's medical information, and, if necessary, to merge or collate medical records and information from more than one EMR system, e.g., for the same patient. Such healthcare provider systems, could include online appointment systems for one or more medical professionals, e.g., the user's primary care doctor, cardiologist, allergist, dentist, and physical therapist. The service-oriented, integrative networking system 200 could, therefore, include a calendar feature for making such appointments, which could communicate with a calendaring program of the user. (e.g., MS Outlook). In such cases, appointments made in the medical provider's system could be maintained in a calendar within the service-oriented, integrative networking system 200 and/or another calendar system of the user.

Such 3rd party systems could include other online systems, e.g., such as search engines, social and professional networking sites, gaming sites, online publications (e.g., newspapers, journals, etc.), ecommerce sites, entertainments sites, and so on, e.g., Facebook. LinkedIn, YouTube, Google, Amazon, MapQuest, eBay, Wall Street Journal (online.wsj.com), New England Journal of Medicine (NEJM.org), etc. In such cases, access to such systems 30 could be provided via the user's profile in the service-oriented, integrative networking system 200.

Such 3^{rd} party systems could include marketing systems 40, which can provide advertisements via the user's profile pages. Such ads can be based on the user's profile, web sites visited, medical information, information associated with the user from other 3^{rd} party sites linked to service-oriented, integrative networking system 200, and so on, as examples. Ads could be pushed to service-oriented, integrative networking system 200, or pulled by it from marketing systems 40.

Users could access the service-oriented, integrative networking system 200, via any type of network enabled device 50, e.g., cellphone, personal digital assistant, electronic tablet, personal computer (e.g., laptop, desktop or workstation), and so on.

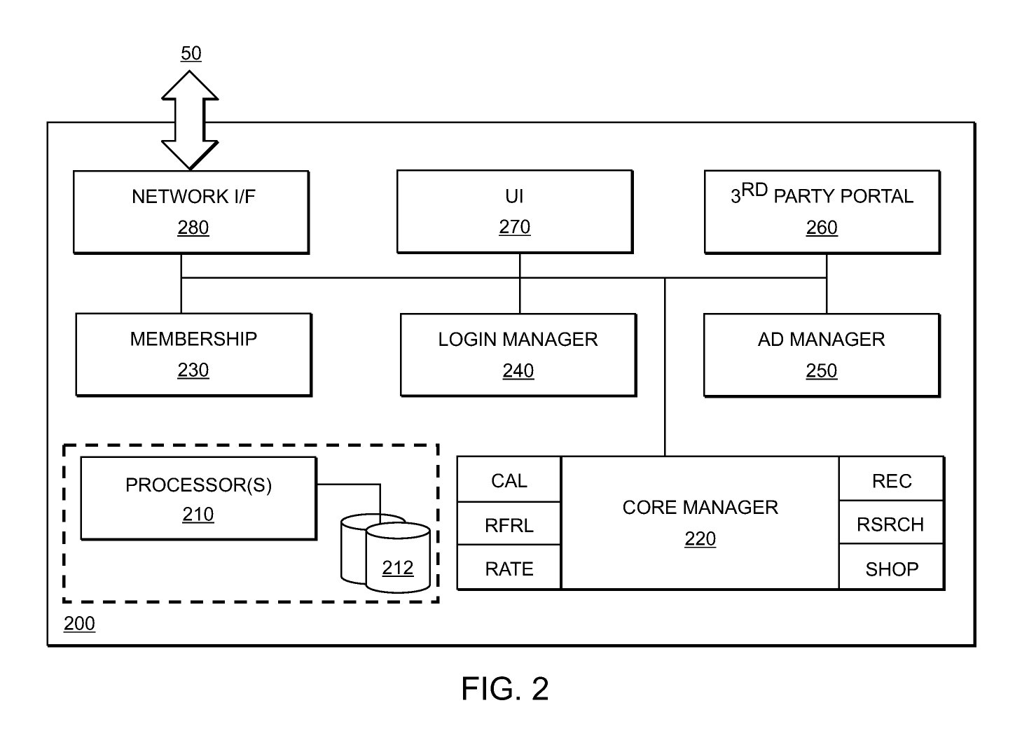

FIG. 2 is a functional block diagram of an embodiment of service-oriented, integrative networking system 200, in accordance with aspects of the present invention. In FIG. 2, elements are depicted as being generally collocated, but they could be variously distributed across different physical systems in other embodiments. The embodiment of FIG. 2 may be considered to depict a service-oriented, integrative networking platform, e.g., a combination of hardware and software (and possibly firmware) uniquely configured to provide an integrated, cooperative set of processing and functionality that is accessible by a wide variety of users for performance of a specified set of service-oriented, integrative networking tasks.

In FIG. 2, system (or platform) 200 includes one or more processors 210 coupled to one or more data storage devices 212. Data storage devices 212 can store computer program code that can be executed by processor(s) 210 to accomplish the myriad functions of service-oriented, integrative networking system 200. The computer program functionality can be embodied, at least in part, in software, firmware, hardware, and/or combinations thereof. Data storage devices 212 can include any of a variety of types of presently known or later developed types of storage media and memory types, e.g., including various types of volatile and/or non-volatile memory.

In FIG. 2, the myriad functions are represented by different functional modules, which could be represented differently in other embodiments. For example, a core manager 220 is the engine generally responsible for tasking and managing other functional modules to accomplish the service-oriented, integrative networking tasks. A network interface module 280 generally manages communication with other systems, and the exchange of information, via network 50. Network interface module 280 can include various types of hardware, software, and firmware necessary to communicate via the Internet, as an example.

A user interface (UI) module 270 includes necessary instructions for generating various display screens and processing user interactions with system 200, under the control of core manager 220—i.e., based on the functions the core manager 220 initiated in response to user (or other) inputs.

A membership module 230 includes necessary instructions for creating and maintaining accounts on system 200, whether personal user accounts, service provider (e.g., doctor) accounts, healthcare organization accounts, and so on. Generally, membership module 230 includes functionality for creating and maintaining accounts for a variety of different types of entities. The membership module 230 is configured to enable users to setup profiles, including setting up different profile pages (which could be tabbed) that are selectively exposed to different sets of connections. Membership module 230 in conjunction with the UI module 270 can integrate content within each profile page, and generate an interactive profile page timeline that can demonstrate not only events on a time scale, but also connections interactions and content on the same timeline.

A login manager module 240 stores and manages user login information and credentials for each entity having an account created and maintained with the membership module 230. Login manager 240 can also be used to store different sets of login information and credentials for an individual user and to allow the system 200 to automatically log a user into a 3rd party system, as variously discussed herein.

A third party portal module 260 manages a user's access to, use of, and information exchange with a 3^{rd} party system, e.g., an EMR system, Facebook, LinkedIn, Google, etc. In conjunction with the 3^{rd} party portal 260, the UI module 270 can display icons within displays enabling a user to simply click through to the 3rd party system. An interface to the 3^{rd} party system can be opened in a new browser window, or within a sub-frame or sub-window of a main system 200 display/window, depending on the embodiment.

As discussed above, login manager 240 may enable a user to login to a 3^{rd} party system without the need to enter the login (or authentication) information for the 3rd party system. In various embodiments, login manager 240 can allow a user to select whether a secondary authentication mechanism is to be activated or used for accessing specific 3^{rd} party systems, such as a security question. In any event, preferably, the secondary information is not the login information for the 3^{rd} party system. However, in some embodiments, the 3^{rd} party portal 260 may simply open or transition to a login screen for the 3^{rd} party system, where the user would be required to enter the login information for that 3rd party system. In various embodiments, a user or system 200 can implement different login scripts for different 3^{rd} party systems.

Third party portal 260 may also access other networks of a user, or databases, and import, or offer to import, information into the user's profile. The 3^{rd} party portal may, for example, also access the user's connections in a 3rd party system and, if the same connections exist in the service-oriented, integrative networking system 200, automatically generate an invitation for the user to connect with the same individuals in the network and community established in system 200, in conjunction with the membership module 230. The 3rd party portal 260 may also scour other systems and/or social networks, generate an initial profile with an invitation for a user to establish a new membership profile within service-oriented, integrative networking system 200.

An ad manager 250 may be include to insert ads into screens displayed to a user. Particularly when logged in, the ad manager 250 may selectively deliver ads based on the user's account information, usage history, connections, medical information, interests, geographic location—which may be gleaned from the user's electronic medical records and/or history, as examples. The ad manager 250 may, for example, deliver ads posted by, sponsored by, or associated with services and goods providers (e.g., doctors, clinics, pharmacies, and/or hospitals) in the user's network. Using the ads manager 250, a user may forward ads to other users, e.g., its own connections, or publically share or associate the ad with the user's profile.

Core module 220 may be configured to perform a variety of functions, as mentioned above, and may include a set of core sub-modules. A representative subset of such core sub-modules is shown in FIG. 2. A calendar sub-module (CAL) may be included that enables appointment making and automatically reflects appointments made with various service providers via system 200. For instance, if a user logs into an appointment system (e.g., a 3rd party system) of its PCP through system 200 and makes an appointment, the appointment can be reflected in a calendar maintained for the user's account within system. Optionally, the calendar module could additionally or alternatively generate an Outlook (as an example) appointment and email the calendar entry to a specified email account or accounts of the user, e.g., personal, work and/or spouses email account. In some embodiments, an appointment calendar is provided for every profile so that approved connections (e.g., the user's doctor, dentist, etc.) can access each other's calendars to make appointments and generate reminders.

A recommendations (REC) sub-module may be included that allows users to make recommendations of various services and goods providers in the network. Such recommendations could be reflected in the profile or account of the user making the recommendation, as well as in the account of the user being recommended. As examples, an individual (patient) user could recommend Dr. Chin as an excellent orthopedic surgeon, and Dr. Chin could recommend Dr. Foley as an excellent gastroenterologist, and so on.

In some embodiments, a user could be provided with a text input box for adding a review, which could be provided in conjunction with selection of a “Recommend” icon (or the like)—where text input need not be required to make the recommendation. The user could also be given various options for recommendation recipients, e.g., all of the user's connections, specified user connections, all connections associated with one or more of the user's profiles, all members of a group, etc. The service provider being recommended could receive an electronic copy or notice of the recommendation and could, at its option, determine if he wants to share the recommendation with other users, connections, or groups in his own network.

A referral (REF) sub-module could also optionally be included. The referral sub-module could present the user with a “Refer” icon, the selection of which enables the user to make a referral of a services or goods provider to one or more specifically identified user, e.g., a connection. The referring user could be given the option to copy the referred services or goods provider on the referral or not.

A rating and ranking (RATE) sub-module can be included that enables users to rate or rank other users. As an example, a user could rate or rank services or goods providers, which could be anonymous. For these purposes, a user could be provided graphical mechanisms that enable the user to choose or input a rating on a predefined scale or from a set of predefined choices. Depending on the embodiment, services and goods providers could earn “reputation” points or status within the system, which could be reflected in an icon or badge optionally displayed in conjunction with the services or goods providers profile.

A research (RSRCH) sub-module could be included that enables a user to research services and goods providers based on a set of user inputs. For example, the user could provide inputs to initiate a search for a physical therapist north of Boston, Mass. The system could provide a list, which may or may not be an ordered list. If ordered, the order could be determined by system 200, user criteria, or a combination thereof. An order could be by shortest distance to a user, by rating (or ranking), as examples, or by some other criteria.

In conjunction with research results, the ads manager 250 could insert targeted ads. The research sub-module could also provide links to electronic articles, support groups, and/or other sources of information related to a condition for which the user is seeking a services or goods provider, in conjunction with the research results.

An ecommerce (SHOP) sub-module can also be included that enables a user to shop for goods and/or services through the system 200. Such shopping could be accomplished by clicking through ads, an ecommerce link (e.g., Amazon, eBay, and/or Craigslist), or returns from a research query.

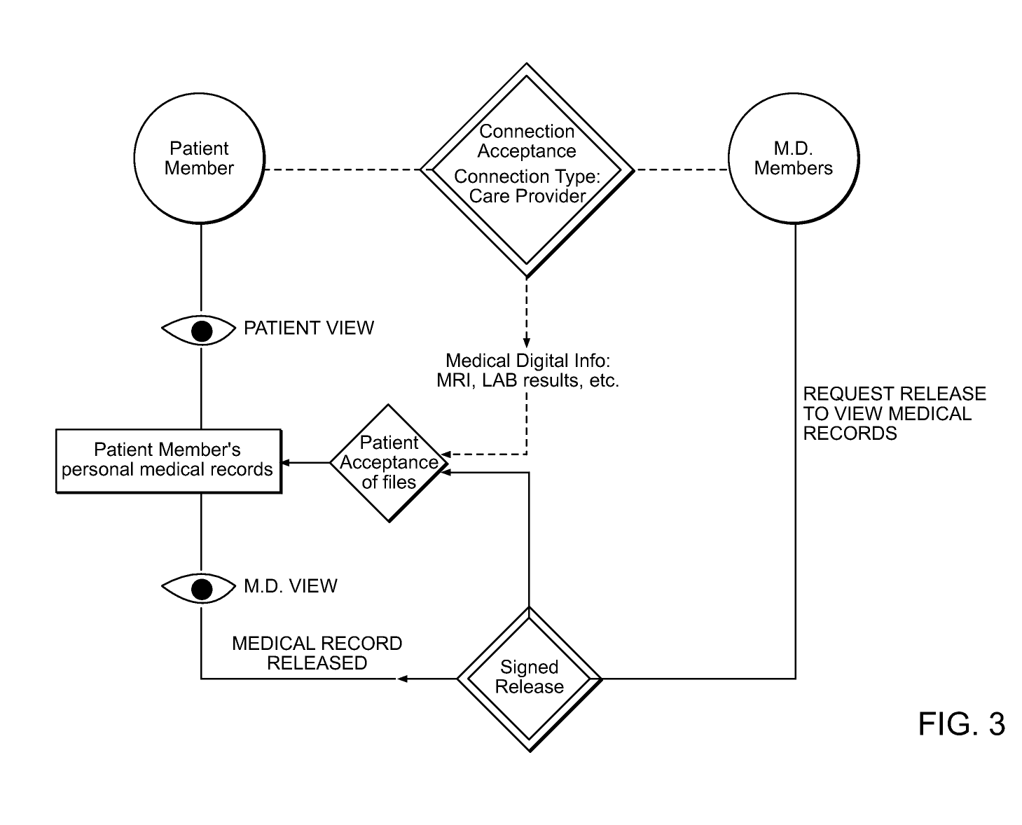

FIG. 3 is a flowchart of an embodiment of a method of obtaining medical records, in the system of FIGS. 1 and 2, in accordance with aspects of the present invention. In this figure, an electronic medical records (EMR) system could be a 3^{rd} party system, as used herein. In this embodiment, a patient member and an medical doctor MD (or practice or other healthcare provider) member are connected within the system. The MD member requires a release from the patient member before it can release patient records. The release could be obtained through electronic communications via the system. In some embodiments, where privacy laws permit, an electronic signature through a secure connection, as an example, may be sufficient. Or, system 200, could provide a downloadable patient release that could be printed signed and faxed or otherwise electronically delivered to the MD member. When the MD member has the patient signed release, the patient member's personal medical records could be made available for viewing, printing, and/or downloading via a display of system 200.

For example, in this embodiment one is only allowed to transfer, not to view, records in a connection's database. A signed release is signed only once for each connection that is made for any type of information to be transferred not only medical, in this embodiment. Once a connection is made, transfers can be done as needed, but a notification is preferably always sent to the receiver. If a third party wants information, it can go directly to the patient or to the MD, but the patient must give permission separately for each request, in this embodiment. During a transfer a user has the option to transfer a specific subcategory of information or all of the information in a category. Therefore, medical information can be organized into categories and then subcategories.

In addition to static medical information that can be transferred, every subcategory of information could maintain a date/time stamp, so there are “tracker” results. Therefore, stored in a user's medical information category can be a subcategory for, as examples, vaccinations and surgeries. Each time the user gets vaccinated, there is a date stamp so the user can track its dates.

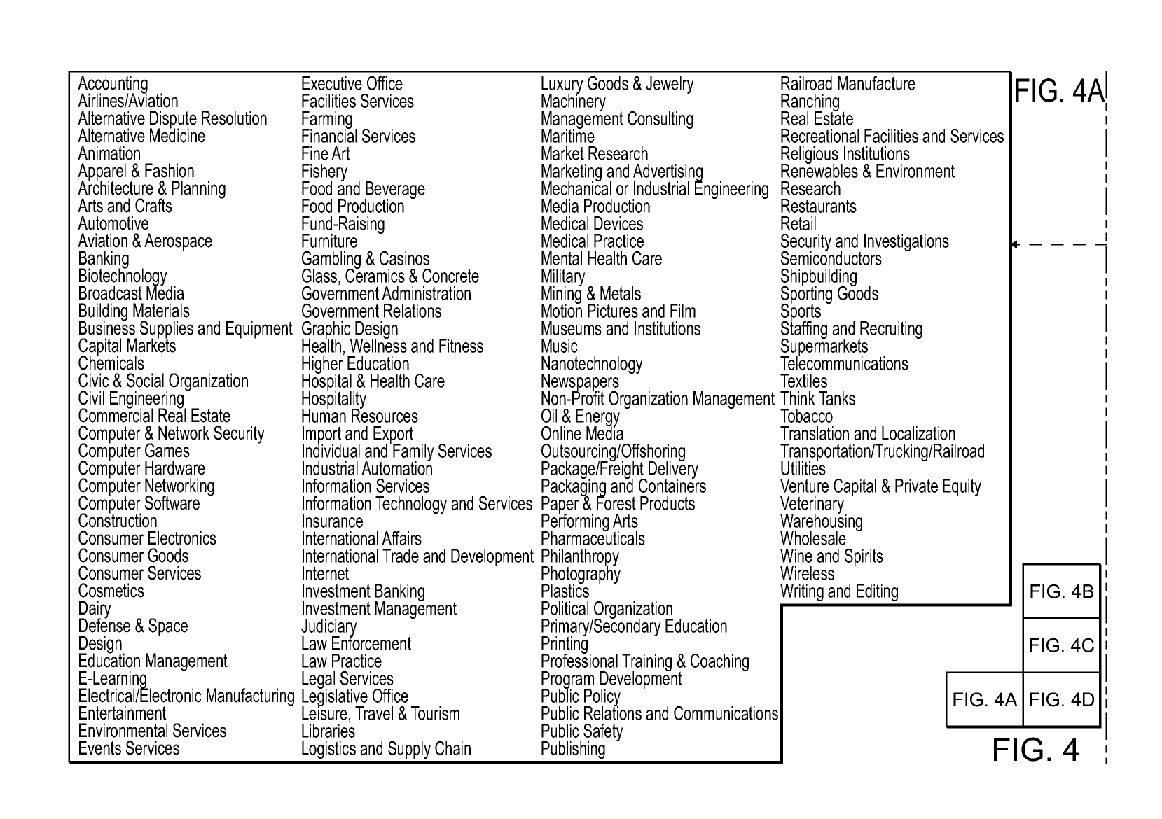

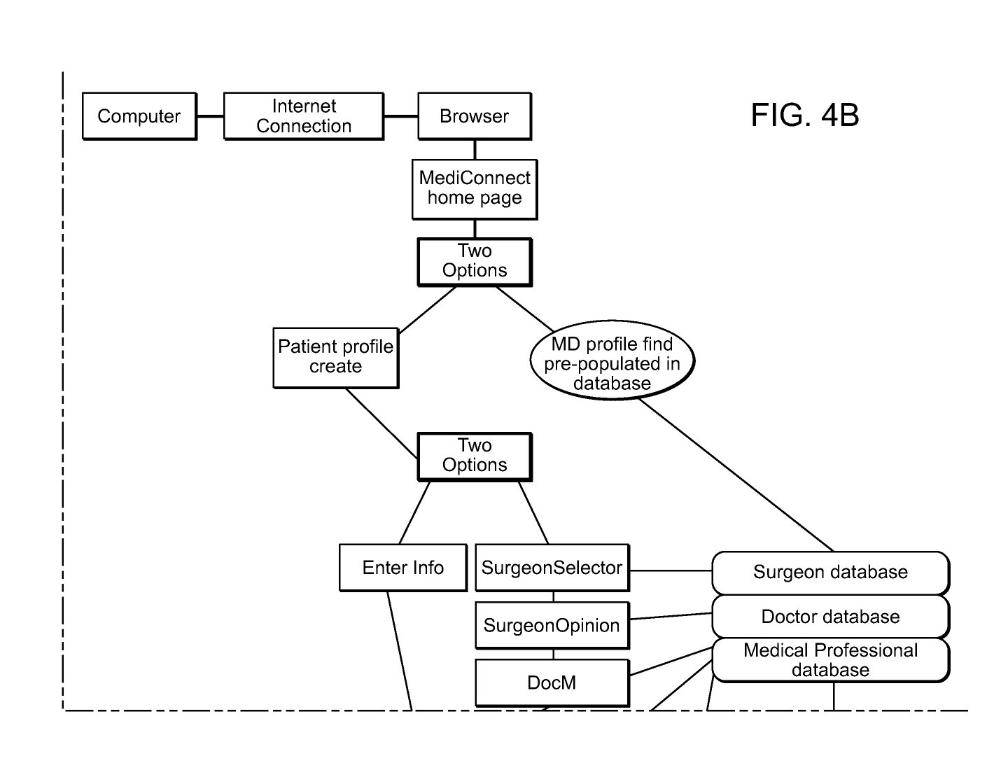

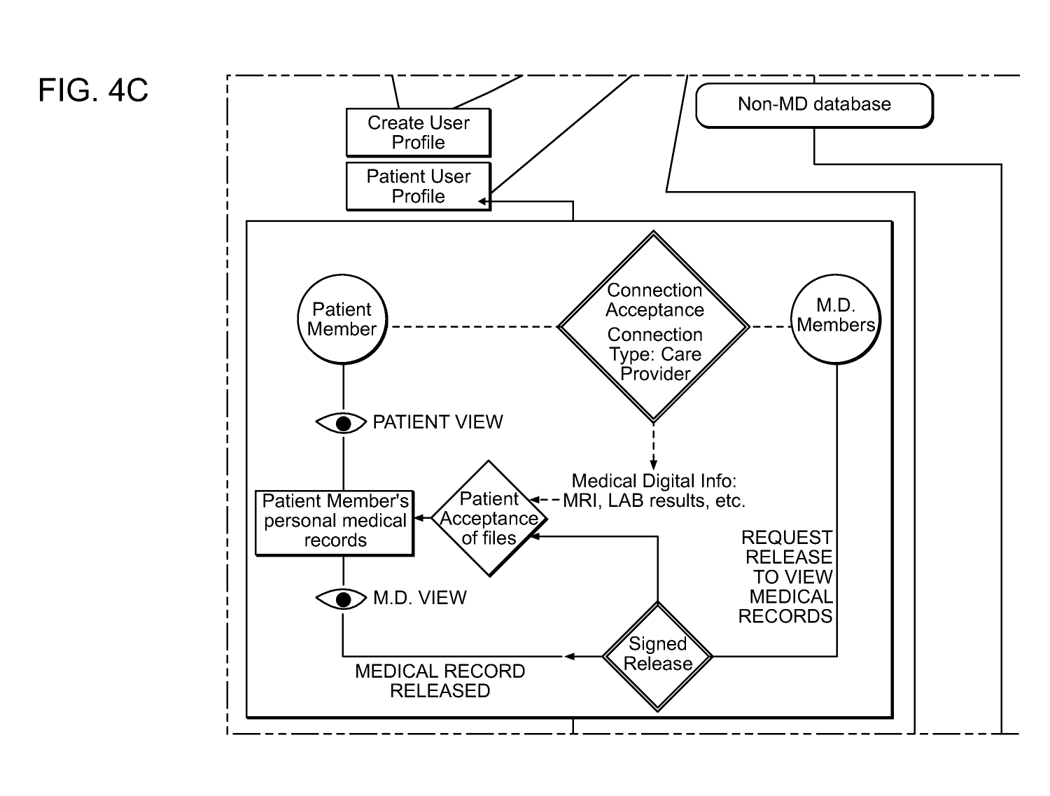

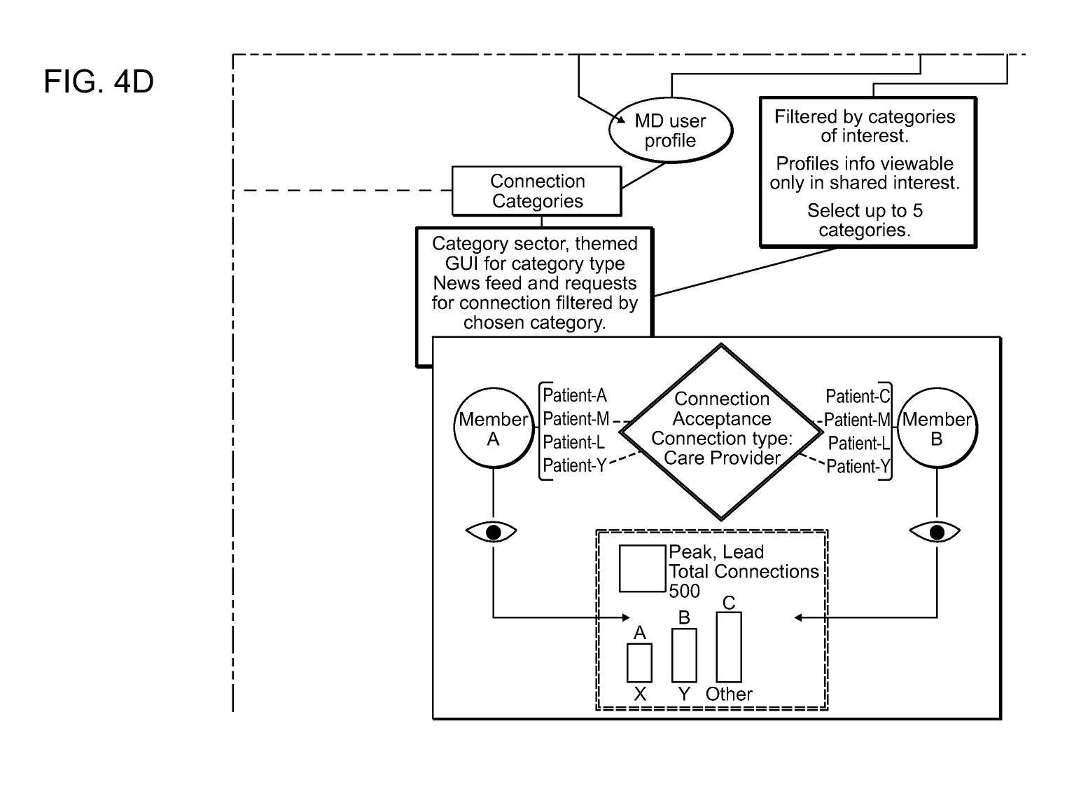

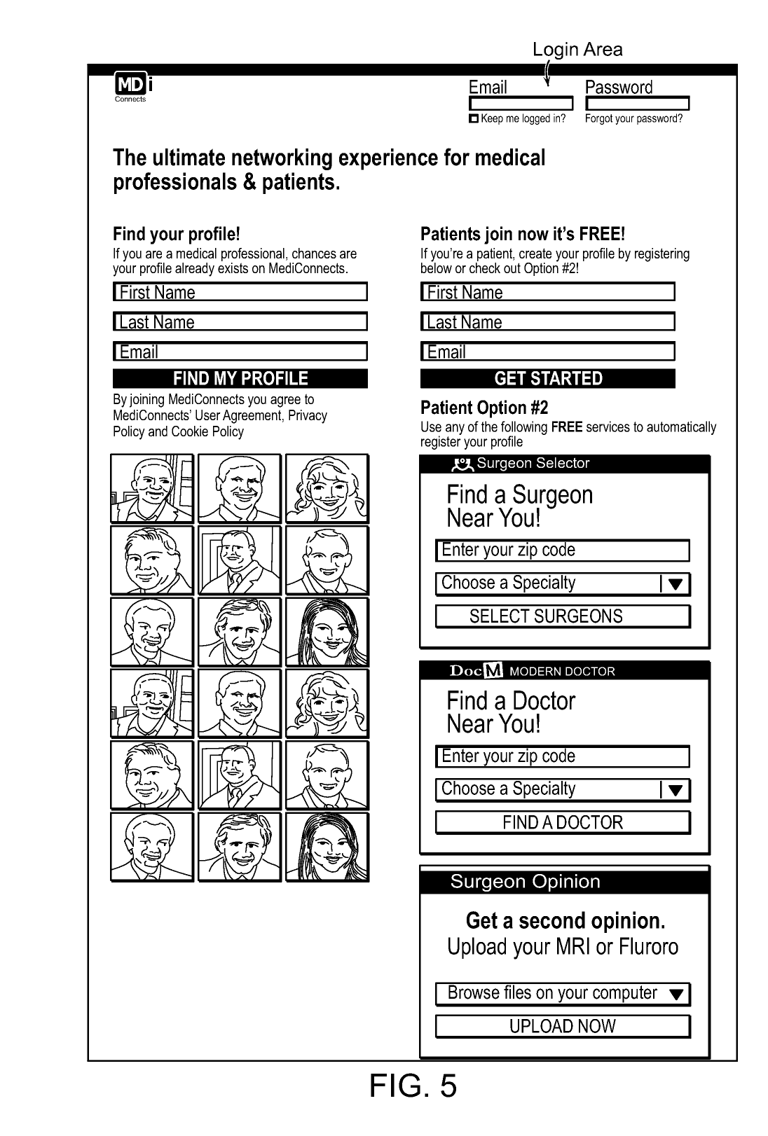

FIG. 4 is a flowchart of an embodiment of a detailed method of interaction and processing accomplished using the system of FIGS. 1 and 2, in accordance with aspects of the present invention. FIGS. 5-9 are embodiments of display screens that can be generated by the system of FIGS. 1 and 2, in accordance with aspects of the present invention.

In various embodiments, each member defines their profile for other potential users to connect only with permission and only limit connections to specific categories of connections not to the entire list of someone's connections. Their connections per category can be advertised for potential connections to view their interests prior to contacting them (example, total connections=100, Investors=40, Friends=24, Doctors=30, etc.). Users could decide to link to certain categories of another member, if approved, only based on their interest. One of the key features of the system-provided experience is in qualifying a request for a connection based on the interest (e.g., friend, co-worker, professional, doctor etc.) and what they can be contacted for (e.g., investment, jobs, reference, date etc.). Every person, doctor and business can be interested in being a service-oriented, integrative networking system member, wherever they are in the world, so they can access their healthcare services and be connected with a purpose to others.

In this embodiment, a user connects to system 200 over the Internet via a browser. At a home page (see FIG. 5), a user can be given at least two options, depending on whether the user is a patient or a medical professional. As a patient, a user can be required to create a profile. However, in some embodiments, system 200 may be pre-populated with profiles for medical professionals, e.g., doctors, practices, etc. In such a case, a medical professional member could search the pre-populated database for its profile and confirm, update, or authenticate it, or simply let it exist in its original form, but possibly create unique login information for its account.

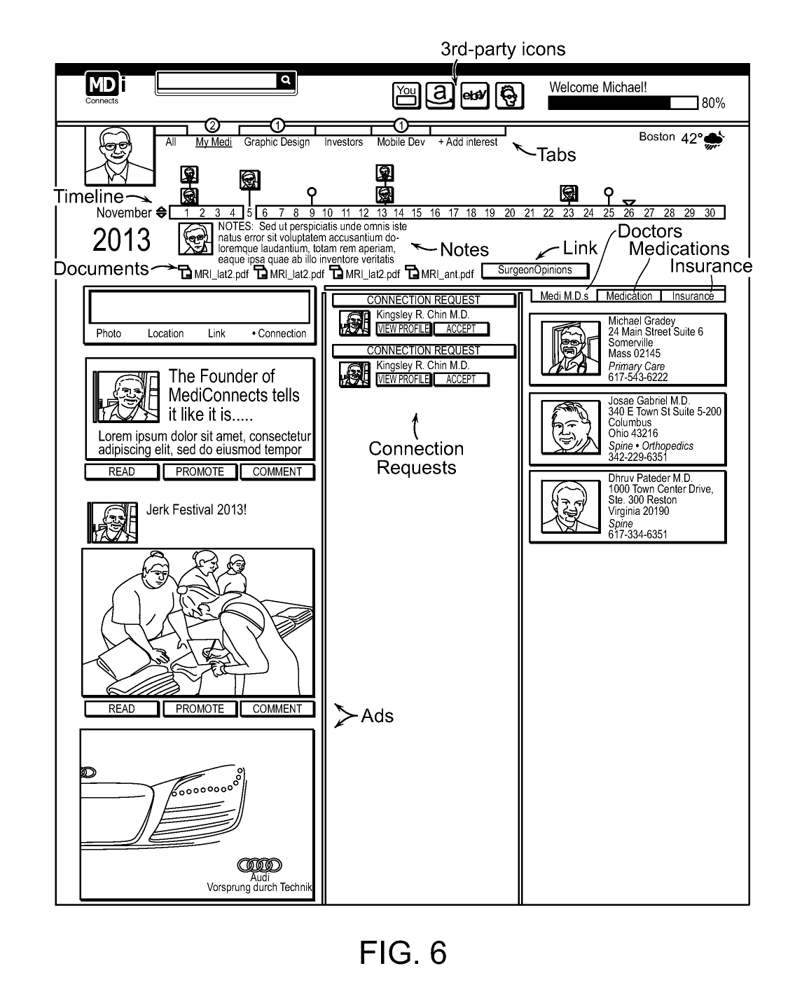

In this example, the user has a variety of tabs, which can be color coded, and frames within which information can be presented. Across the top, as in FIG. 6, a set of 3rd party icons can be provided for the user. Selection of an icon can open a window to the corresponding 3^{rd} party system, preferably without the need for entering login information for such 3^{rd} party systems. The tabs can be user configurable, at least to some extent, and some can be predefined—where the user can dictate, at least to some degree, the content to be presented in a display associated with selection of a tab. The display for each tab can be color-coded to correspond to the color of the tab. And the user can, in some embodiments, chose the color of each tab. A user profile picture can be different for each of its tabbed (profile) page.

FIG. 6 is an example of a user's medical page, which is the tab with the number “2” labelled “My Medi.” The system can be configured to generate a timeline, e.g., as shown. In this example, the month displayed is November and the timeline is annotated with various symbols showing content and/or activity on different dates. Here, when November 5^{th} is selected, notes and documents of an MD are shown. Below the timeline are a set of selectable (e.g., .pdf) documents related to the selected timeline entry. A link to another service, “SurgeonOpinions,” is shown as a link to a system that can provide surgeon opinions, e.g., with respect to a defined condition. Also, connections and connection requests can be visible. In various embodiments, connections can be categorized and different for different categories. For instance, the profile exposed to a user's medical tab can be different from the profile exposed to a user's interest page tab.

In a rightmost column, three tabs exist, for Doctors, Medications, and Insurance. Selection of a tab reveals the current information for that user. In FIG. 6 the Doctor's tab is selected, revealing a list of doctors.

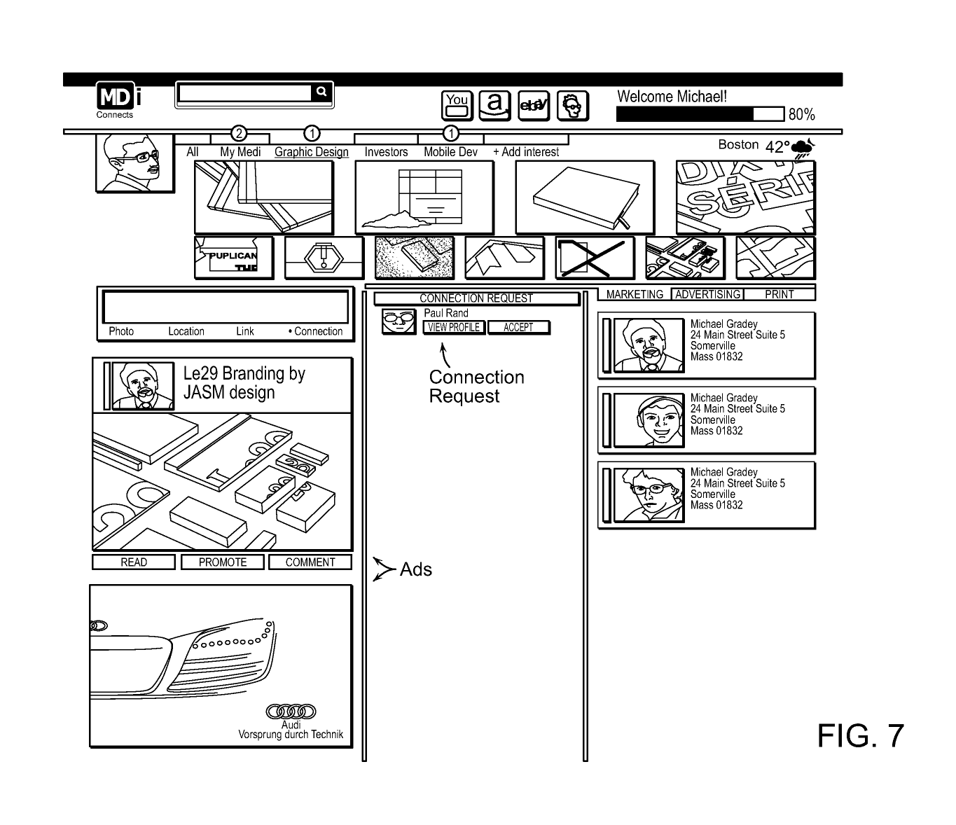

FIG. 7 shows the user's profile page under the selected “Graphic Design” tab, to the rights of the My Medi tab selected in FIG. 6. Here, the color scheme, connection requests, connections, and content are different from the medical profile page for the same user in FIG. 6. Thus, system 200 enables a user to have multiple profile pages in a tabbed arrangement in a single interface and single account. Ads, connection requests can also be provided for this profile page. Note that the connection requests for the same user are different under different tabs.

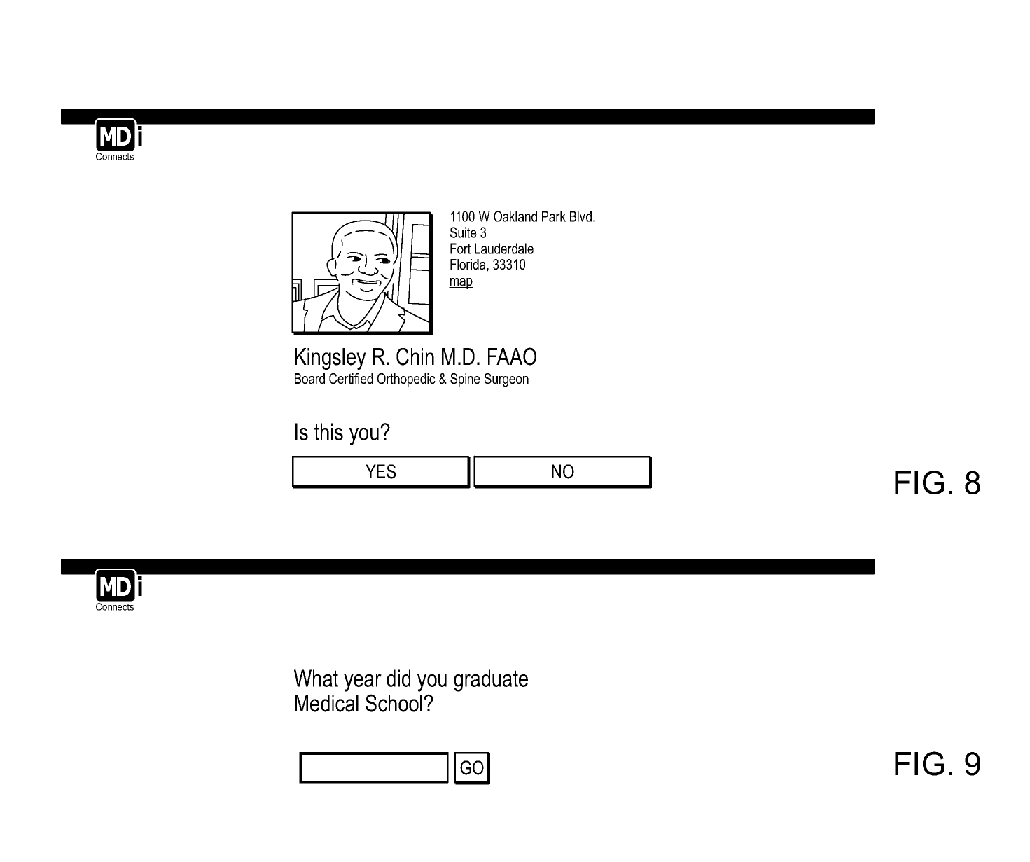

FIG. 8 shows a screen provided to a medical professional, Kingsley R. Chin M.D. FAAO. In this case, the system's database has pre-populated a profile for Dr Chin. In FIG. 8, the system 200 is prompting Dr. Chin to engage with the system to authenticate, approve, and or confirm his profile to become an active member.

FIG. 9 is a screen prompting Dr. Chin to provide information not presently in the database, but for which a field exists for medical professionals in the database. This screen is merely a non-limiting example of a prompt for information from a medical professional.

In accordance with aspects of the present invention, provided is service-oriented, integrative networking system where a user (e.g., a patient) can have a single profile, single login, meaningful connections through medicine, since every person is a patient at some point in its life and has to see a doctor, versus Facebook etc., where use is optional. A user's profile can be a portal to anything on Internet, which allows a user to select connections, have its medical records shared seamlessly with its doctors, and a user can track its appointments, vaccinations, etc.

In accordance with the present invention, there is described a service-oriented, integrative networking system that provides greater efficiencies and time saving for a user, e.g., by having an network of medical resources and other resources available through a single integrate interface, particularly by reducing and/or eliminating the need for multiple logins to access multiple systems that otherwise require separate logins for any number of 3rd party systems—even non-medical systems.

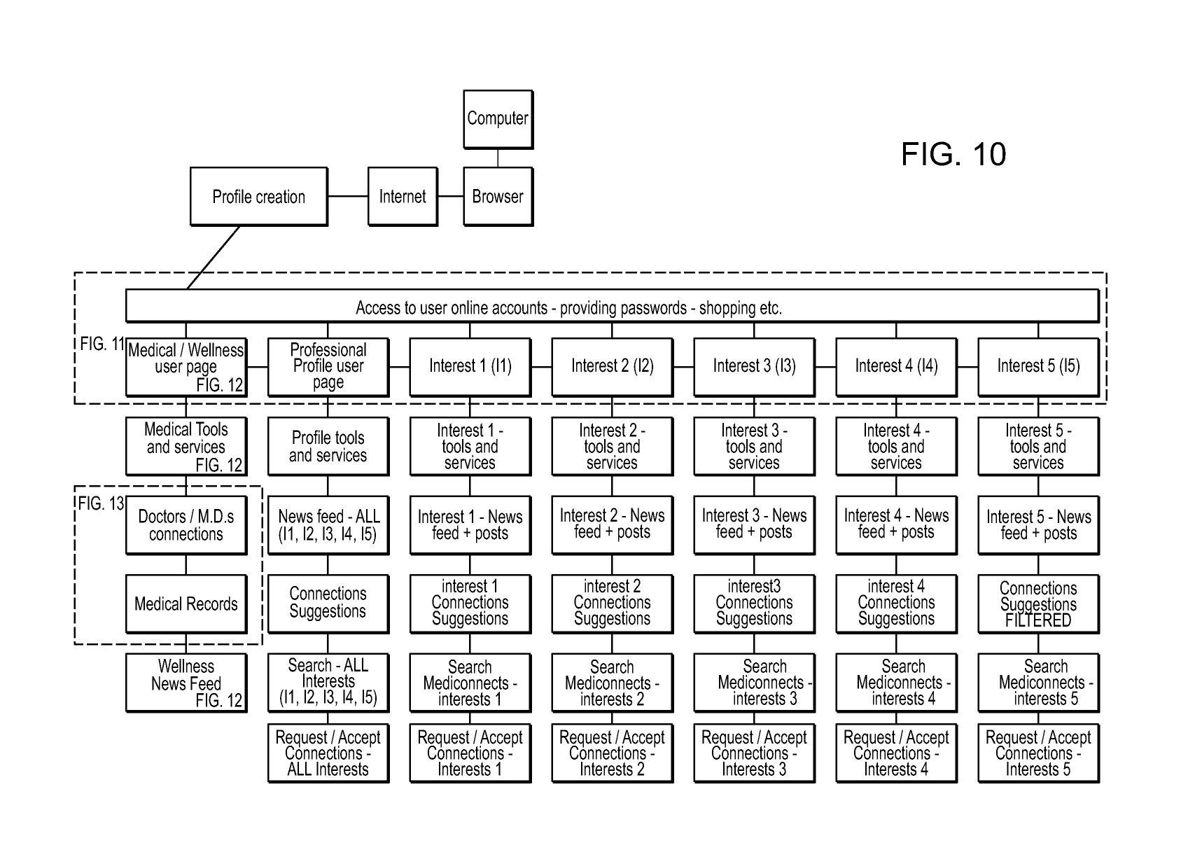

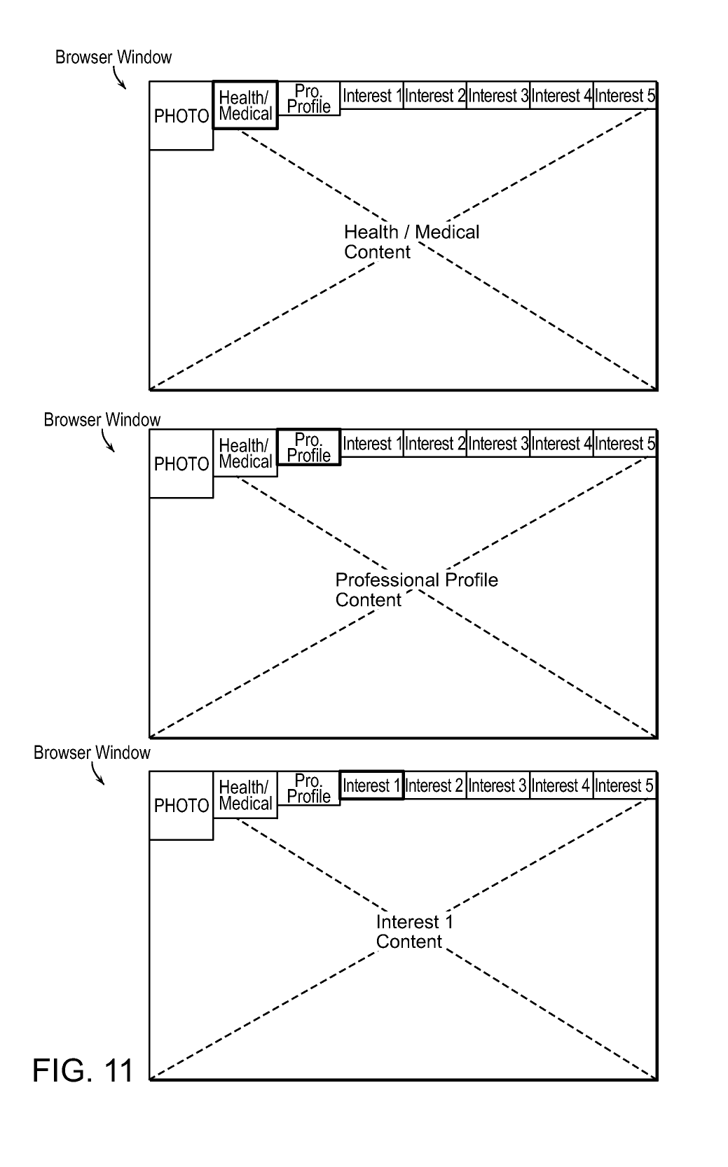

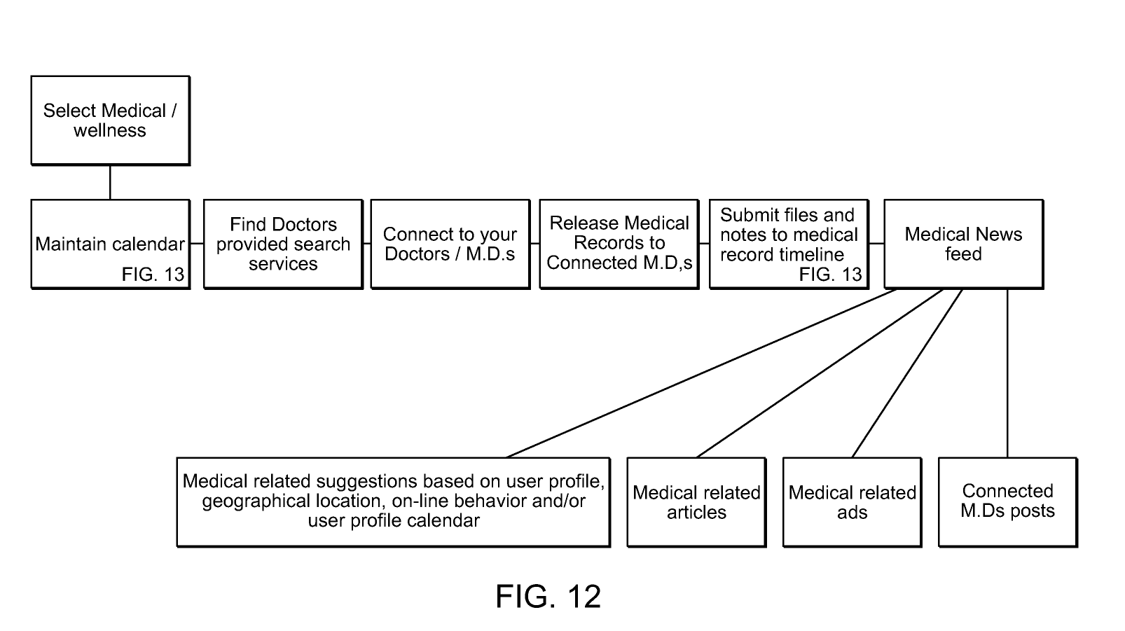

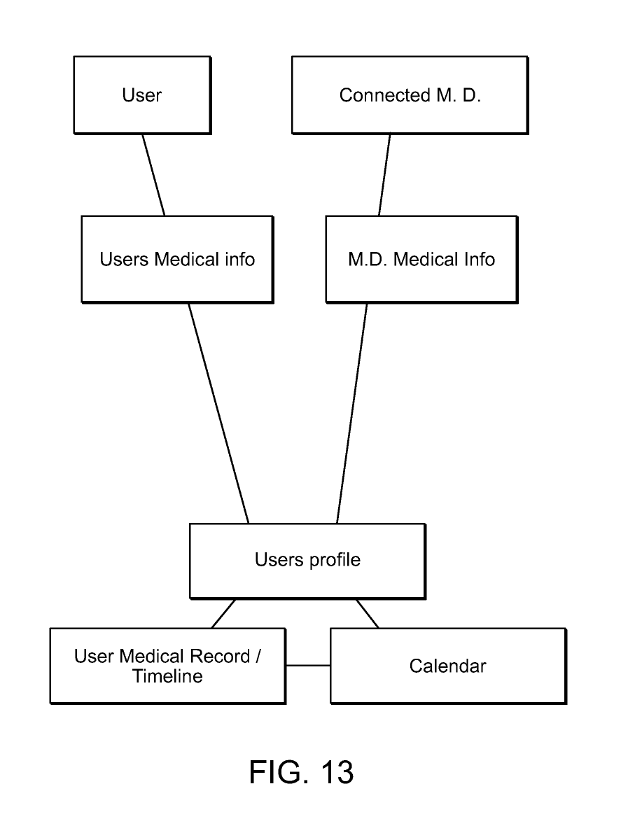

FIGS. 10-13 are block diagrams depicting example embodiments of a service-oriented, integrative networking system, in accordance with aspects of the present invention. These diagrams depict flows among the various functional blocks. In this embodiment, a user can specify a set or interest categories, here 5 interest categories, these categories can be used to acquire connections, which could be auto-populated into user profile. For example, in FIGS. 6 and 7 the tabs represented mechanisms to view these different categories, and add new ones.

In some embodiments, a user can be required to take an affirmative step to maintain connections within an interest category. In other embodiments, the connections can persist until affirmatively deleted (or disconnected) by the user. In some embodiments, a plurality of common interest categories can be used to recommend or auto-populated connections. In some embodiments, a user's deletion of an interest group causes the connections associated with deleted interest group to be deleted. In some a user can simply refresh an interest category and delete some or all of connections for the interest category, without deleting the category itself.

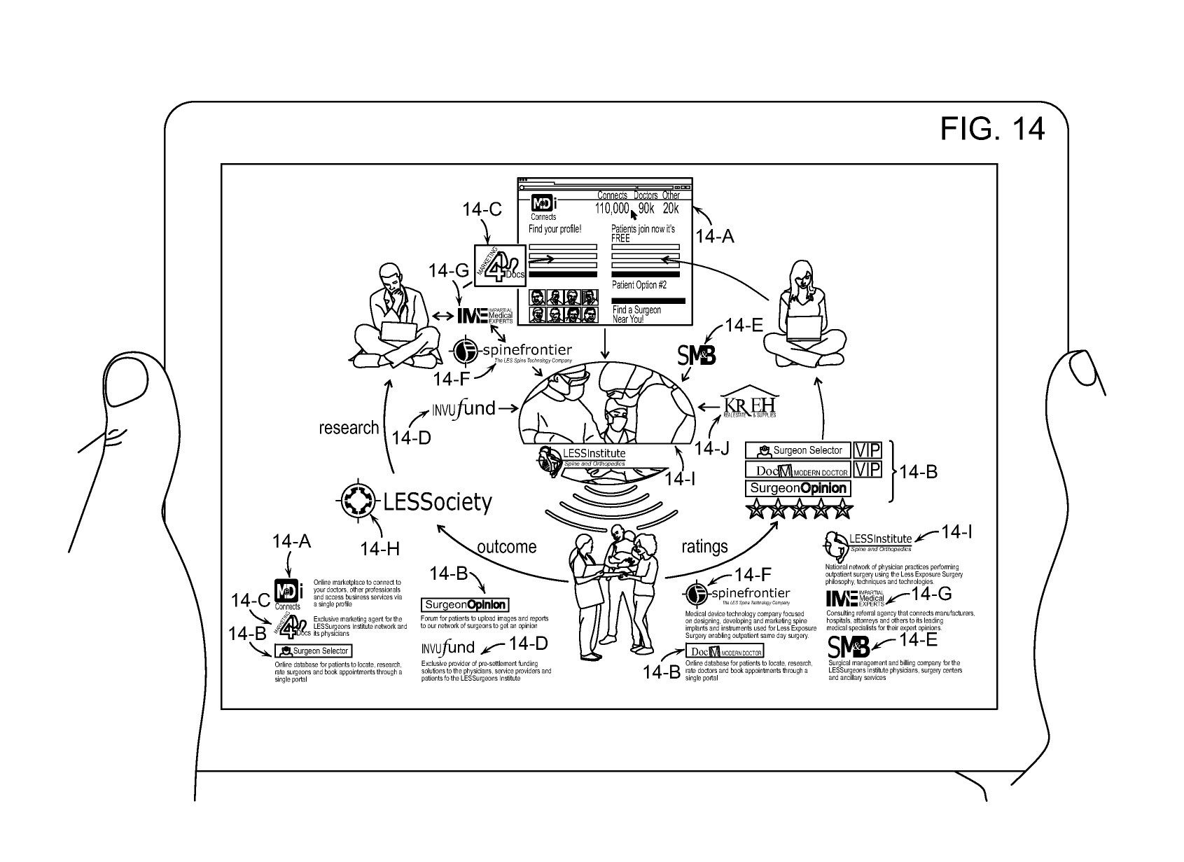

FIG. 14 (KIC) is an embodiment where the service-oriented, integrative networking system of the present invention (part 14-A, referred to as MediConnects) is integrated into a larger system, network, and method (FIG. 14 in its entirety), where the service-oriented, integrative networking system (part 14-A) is used as a hub, integrator, portal and/or access point to a plurality of 3^{rd} party systems (FIG. 14 parts B, C, D, E, F, G, H, I and J) that, while not essential, can all be within or related to a specified field, e.g., the medical field in this example.

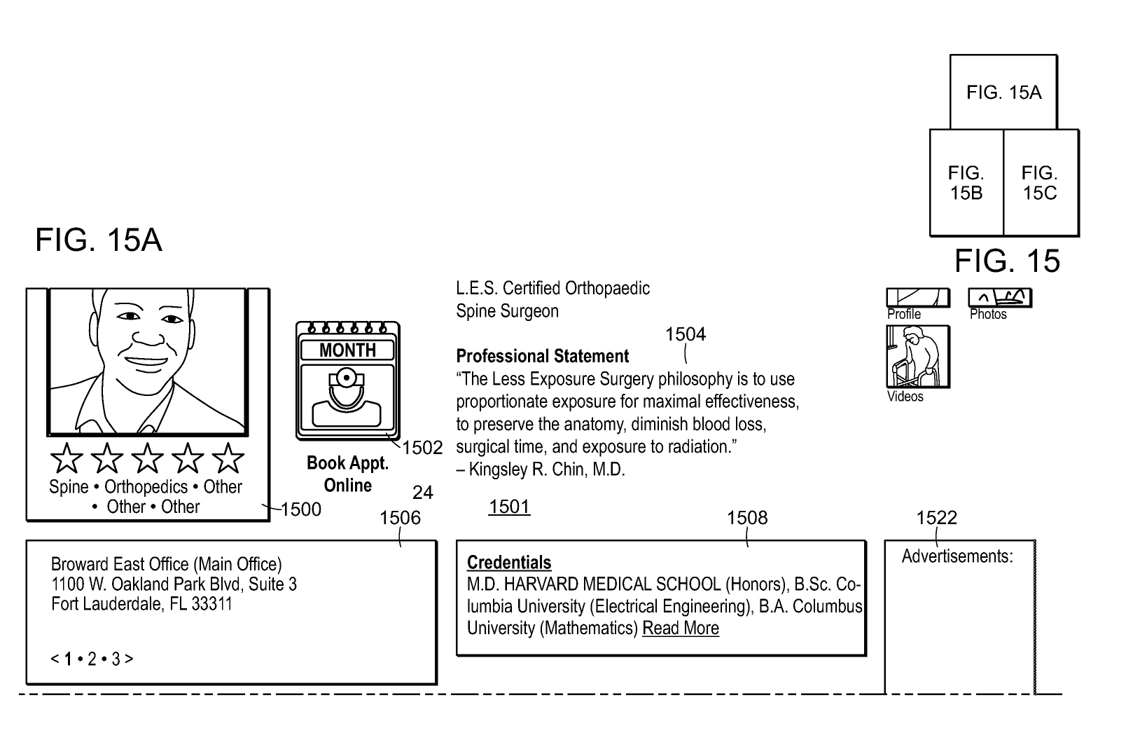

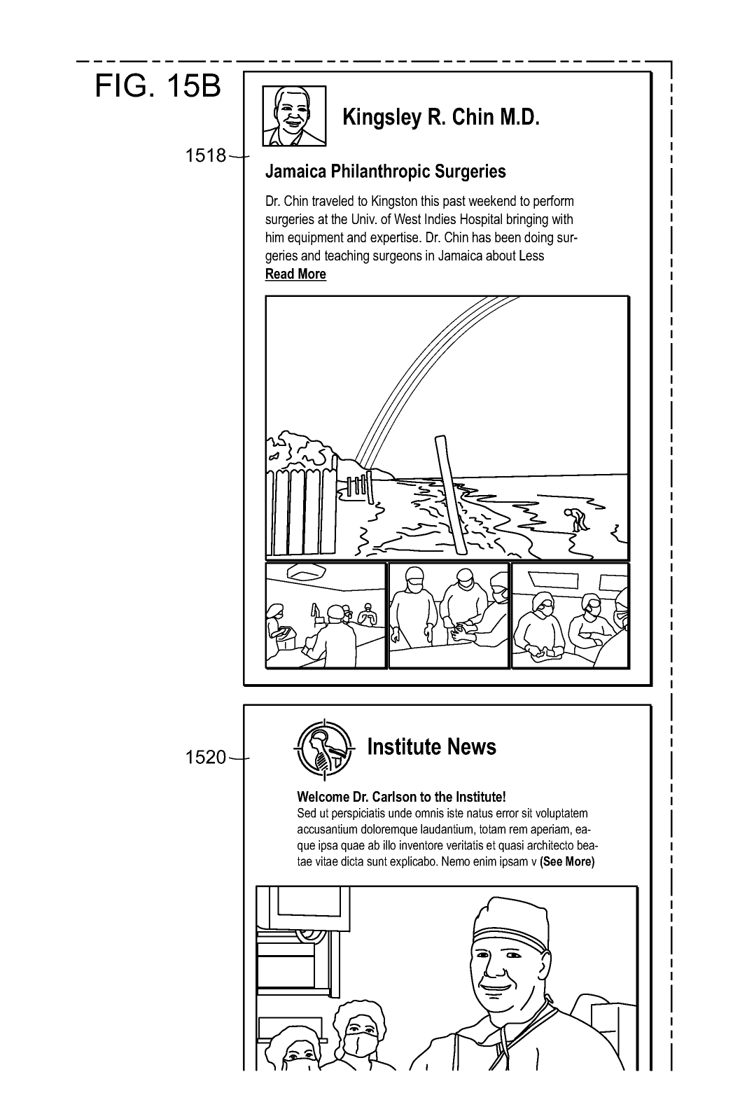

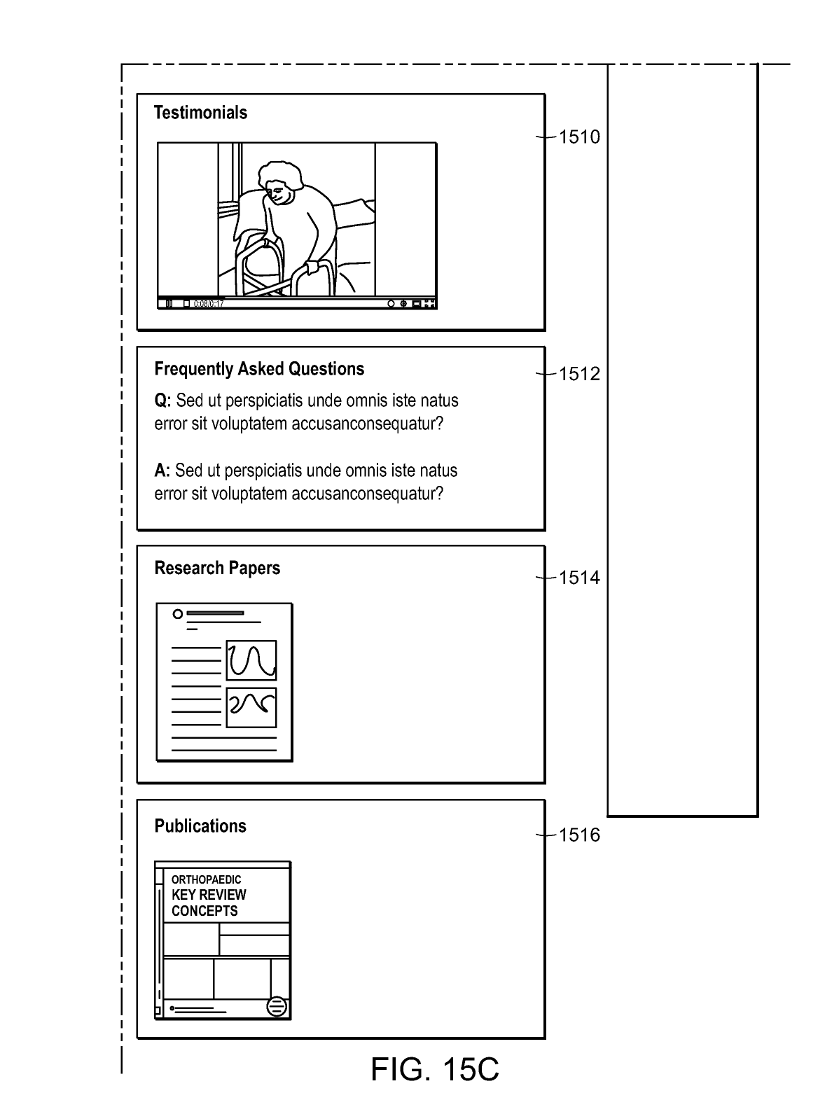

FIG. 15 is an example embodiment of a physician's homepage 1501, such as may be created within a system in accordance with principles of inventive concepts. This example embodiment includes fields for a physician's image, rating, and specialties 1500, an appointment calendar 1502, professional statement 1504, address 1506, credentials 1508, and testimonials 1510. A physician's homepage may be entered, for example, as a result of a search, which may be coordinated by a system in accordance with principles of inventive concepts, as will be described in the discussion related to the following figures.

The physician information available to patients will be pre-populated in the database and searchable by patients. This pre-populated physician information includes name, practice location including coordinates as well as postal code prior to the physician affirmatively subscribing to LESS Online database service. Should a patient select such a physician and request an appointment with this physician, the physician profile is turned off and LESS Online personnel are notified of the patient's interest in this physician. LESS Online personnel contacts the physician and asks the physician to join the LESS Online system. If the physician refuses, that physician's pre-populated profile data no longer appears in search results and the patient is given a member physician's information.

The ratings 1500, a five-star rating system in this example embodiment, may be compiled from a patient-rating system, for example. In example embodiments, the ratings may be adjusted, for example, by discarding a certain percentage of highest and lowest ratings, or by allowing physician feedback, for example. The ratings may also include contributions from the physician's peers, resulting in a blended patient/peer rating system.

The appointment calendar 1502 allows a patient to directly book appointments. Safeguards are in place to ensure patient confidentiality and to ensure that no one overbooks, for example. Such safeguards may include the requirement for a patient log-in. To book an appointment patient enters their name, an email and a password, and this information is used by the system to create the patient's user profile.

Testimonials 1510 may employ any format, such as written, audio, or video, for example. Such testimonials may be supplied by patients, peers, or a combination thereof. The testimonials may be acquired, catalogued, and displayed by a system in accordance with principles of inventive concepts, with little or no burden on the physician whose homepage displays the testimonial. A field 1510 may be provided for the presentation of frequently asked questions, along with their answers. Research papers the physician has been involved with may be listed, with a synopsis and link, in field 1514. Other publications may be accessed from field 1516. Field 1518 provides the physician with a forum for discussing outside activities, such as charitable works, teaching programs, or other activities, especially those involving his particular expertise. Field 1520 may provide news regarding a facility or organization with which the physician is involved. Advertising may be presented in field 1522, for example.

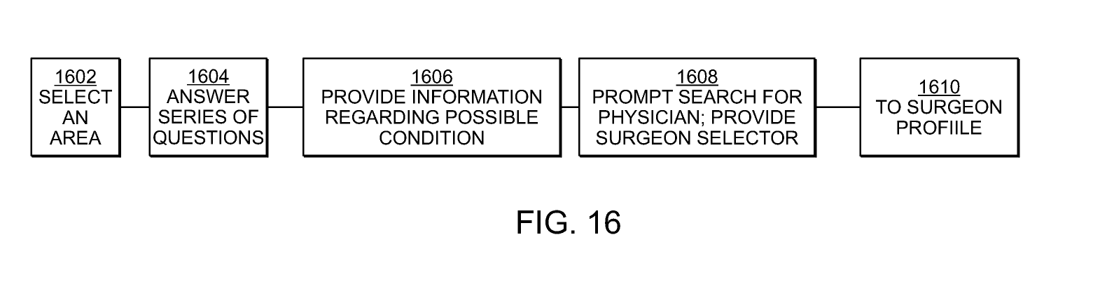

FIG. 16 is a flow chart of a patient education process such as may be included in a system in accordance with principles of inventive concepts. As will be described in greater detail in the discussion relate to the following figures, this process flow may be initiated, for example, when a patient searches for diseases or afflictions that may relate to their own symptoms. In this example embodiment an interactive icon may be employed in step 1602 to allow a patient to describe their condition. For example, the interactive icon may be of a musculoskeletal system, with particular regions highlighted for interaction/selection by a patient. One of the highlighted regions may be selected by a patient in order to focus further inquiry into the patient's condition. After selecting a musculoskeletal region of interest in step 1602, the process proceeds to step 1604, where the patient is prompted to answer questions, which may be a series of successively more narrowly-focused questions, regarding their symptoms. Conventional processes, such as Boolean processes may be supplemented by neural network, or “fuzzy logic,” processes in such a diagnostic process in accordance with principles of inventive concepts.

After the patient answers the questions, the system has sufficient information to provide the patient with information about medical conditions which may correspond to the patient's symptoms and the process may proceed to step 1606, where information related to the possible condition(s) is provided to the patient. Additionally, one or more procedures that address the identified condition(s) may be presented to the patient. The suggested procedures may be presented to the patient using any of a number of media, including written word, graphical representations, animation, or video, for example.

After reviewing such information, the process may proceed to step 1608, where the system may assist a patient in locating a physician who performs one or more of the suggested procedures. In example embodiments, a system may prompt a user to search for a physician using geographical (for example, zip code) and/or other criteria. Other search criteria may include, for example, identifying which physicians within a geographical regions are certified for a certain procedure or are members of a specific practice group, or limit the search to physicians with a rating above a patient-supplied threshold. By integrating the informational functions of symptom/condition association with potential treatments, a system in accordance with principles of inventive concepts takes a first step toward providing a patient with a highly integrated, streamlined, automated approach to patient care. By taking the further step of assisting a patient in locating a physician who performs one of the suggested procedures/treatments, a system in accordance with principles of inventive concepts provides a fully-integrated system for patient treatment. Further diagnosis may be performed by a physician contacted by a patient through the system and/or directly through expertise provided by the system.

In step 1610 a patient may select a physician that has been identified by the system as meeting the criteria set forth by the patient during the previous. That is, a physician who performs the recommended procedures, is located within the patient-supplied geographical area, and is associated with a particular network of physicians. The network could be system-supplied; for example, all physicians with a particular certification, or patient-supplied; for example, all physicians with a rating of four stars or higher. As a patient makes an appointment with a physician, that patient's information will be used to create a patient profile within this system.

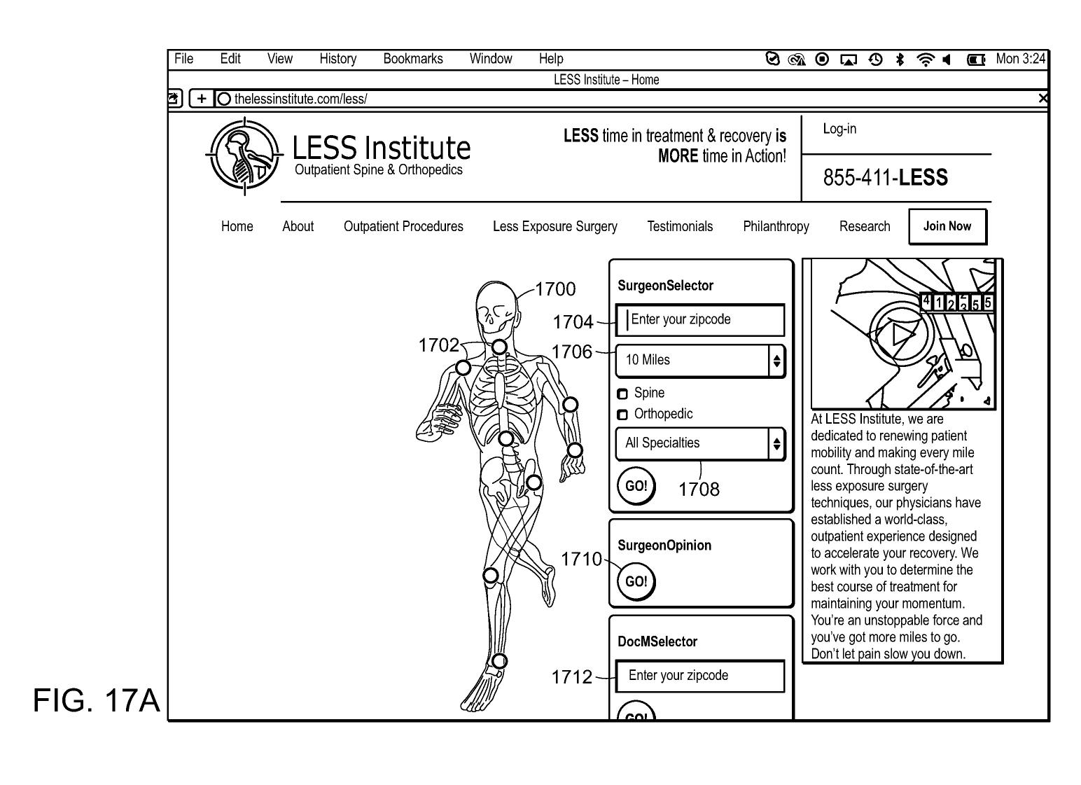

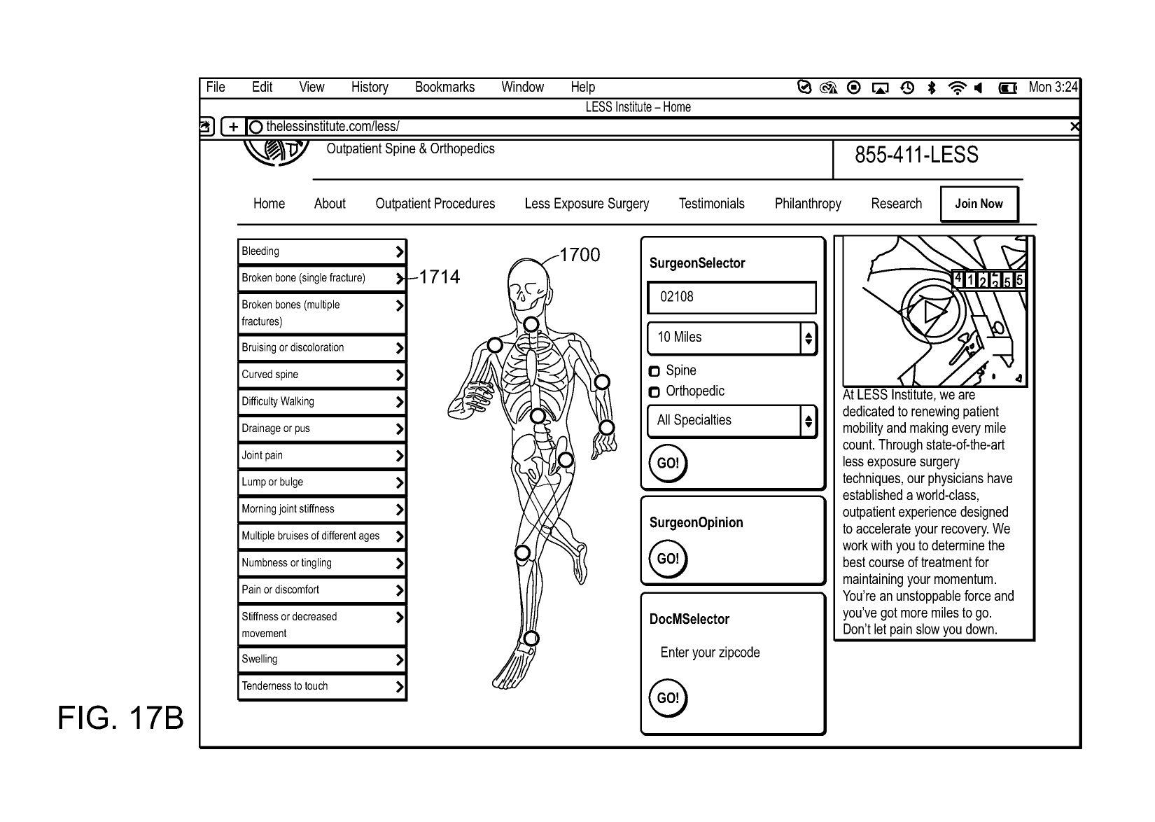

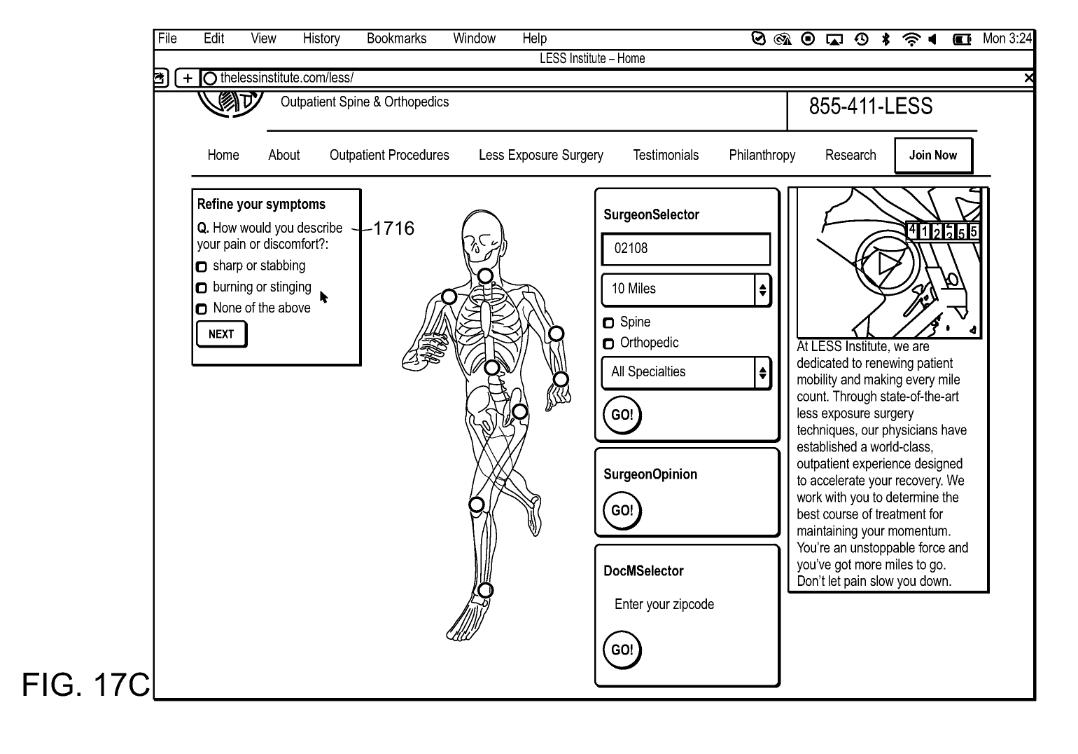

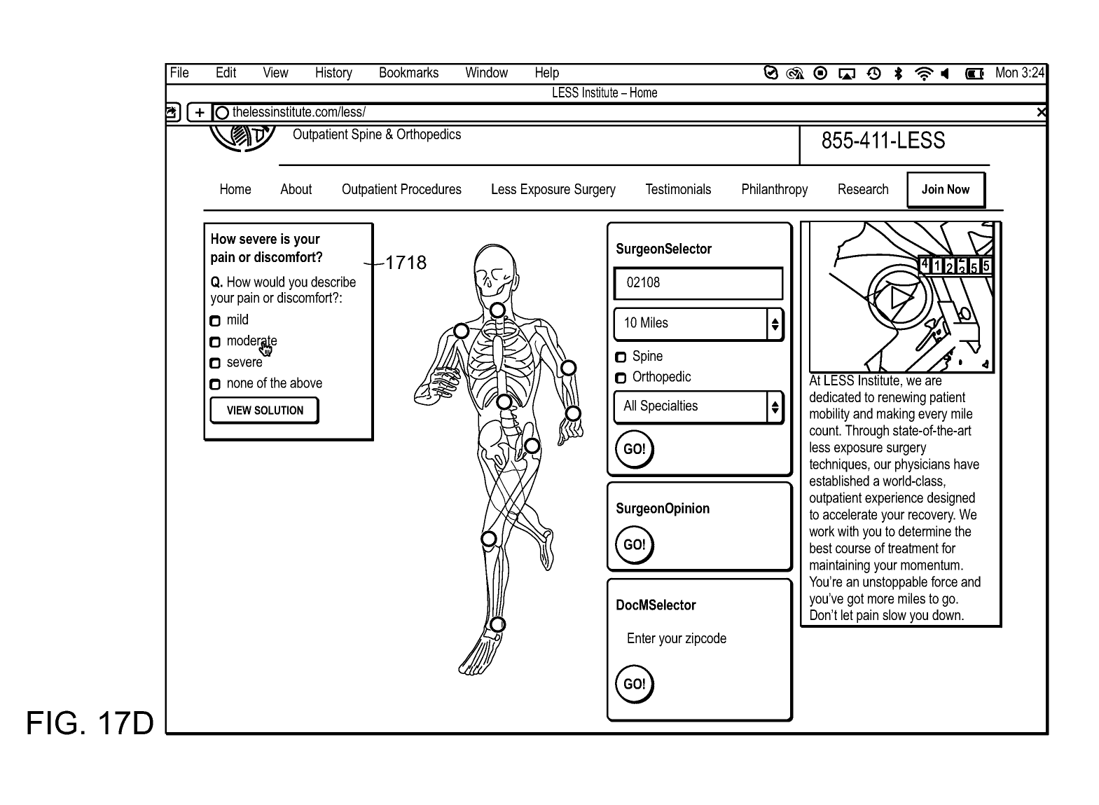

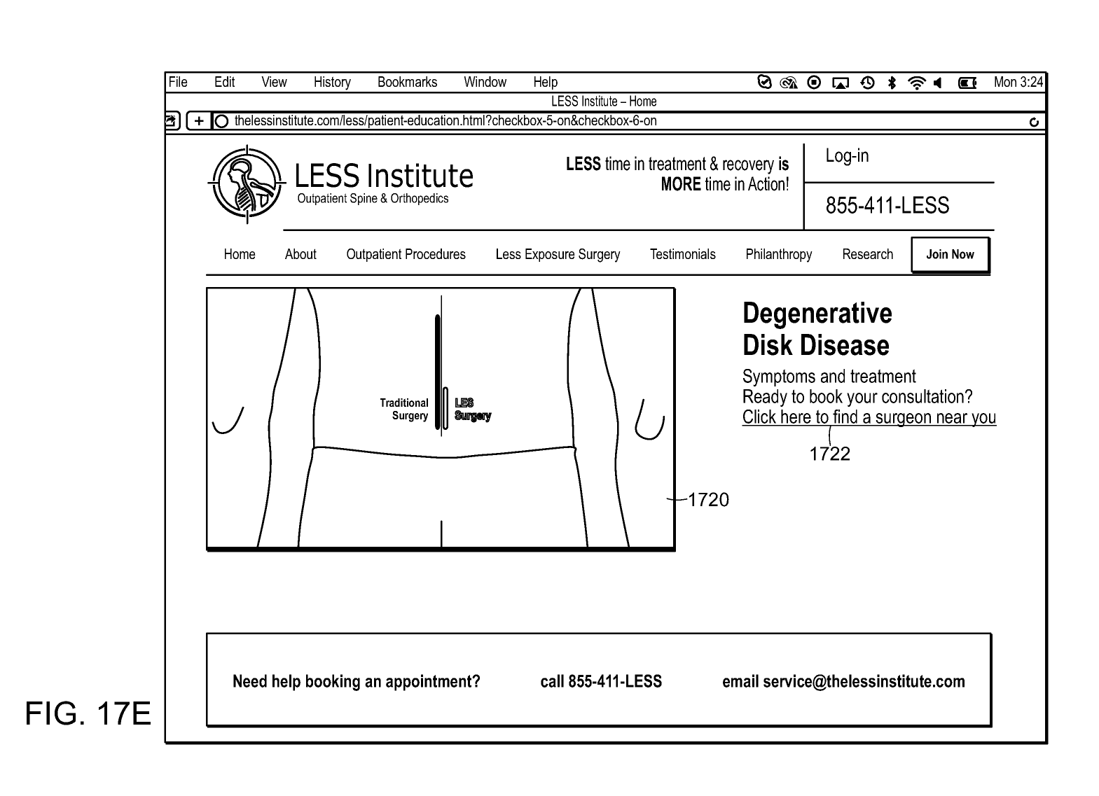

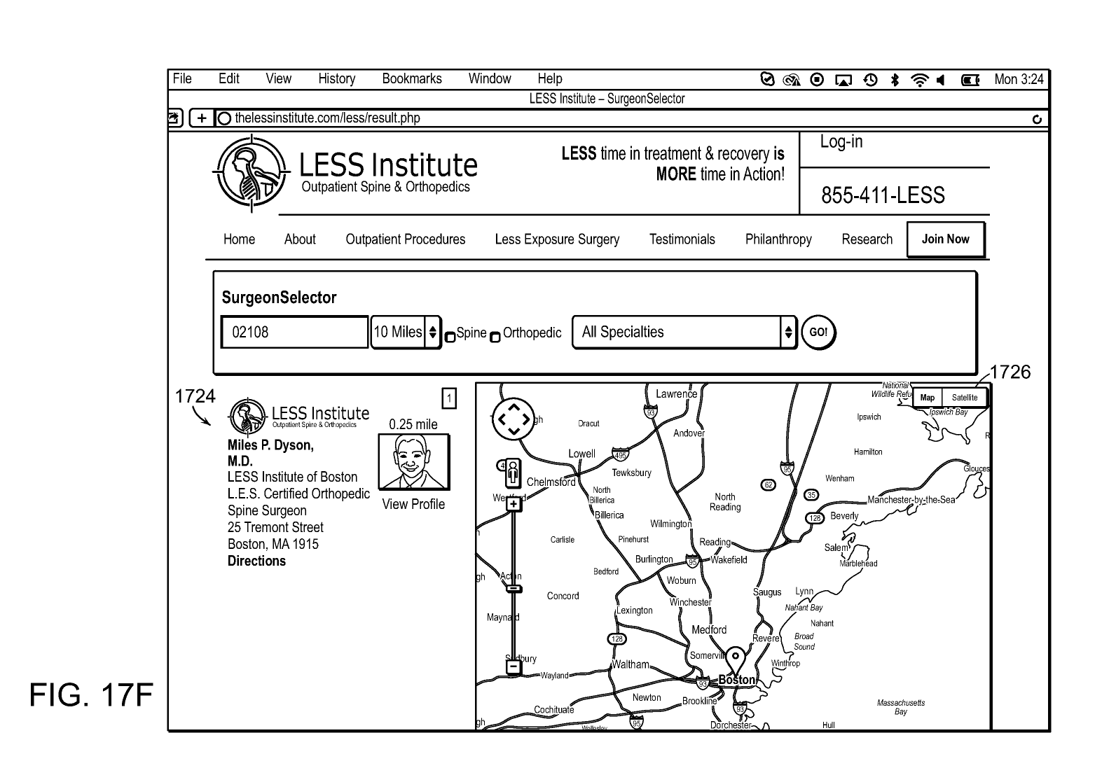

FIG. 17 depicts an example embodiment of an interactive screen that allows a patient to supply symptoms to a system in accordance with principles of inventive concepts, as described, for example in the discussion related to steps 1602 and 1604 of FIG. 16. In this example embodiment a musculoskeletal image 1700 includes several points 1702 which allow a patient to indicate to the system the region of their body where they are experiencing symptoms. Further steps will be described in the discussion related to the following figures, but, also on this page, a surgeon selector field includes interactive boxes 1704, 1706, and 1708 that allow a patient to indicate his location, a range from his location where he would be willing to travel to see a physician, and a specialty selection box, respectively. Although the patient's zip code is used in this example embodiment, other location techniques, such as global positioning system (GPS) location is contemplated within the scope of inventive concepts. A box 1710 allows the patient to obtain an opinion from a physician, a surgeon in this example embodiment, in response to patient input. This opinion may supplement (a second opinion, for example) or stand instead of an opinion developed automatically by a system in accordance with principles of inventive concepts. The DocMSelector interactive box 1712 accesses medical or dental professionals that do not specialize in surgical procedures, enabling a patient to review a DocMSelector professional's credentials and optionally make an appointment with such a professional. As a patient makes an appointment with a DocMSelector professional, that patient's information will be used to create a patient profile within this system

In FIG. 17B, after a patient has activated an icon 1702 located, in this example, generally in the gut region of icon 1700, a menu 1714 drops down to guide the patient through a more detailed description of symptoms, offering options such as, “Bleeding,” “Broken Bone,” “Bruising,” etc. After selecting one of these symptom descriptions, the system supplies the patient with an interactive box 1716 (FIG. 17C) that allows the patient to refine his symptom description, allowing him to, for example, indicate that the pain he is experiencing is “sharp or stabbing,” or “burning or stinging.” Next, the system offers interactive box 1718 (FIG. 17D) which allows the patient to further refine his symptom description. Steps such as these may be repeated at a number of levels and the process flow through such inquiries may be re-directed, depending upon patient responses. These steps correspond, generally, to steps 1604 and 1606 of FIG. 16, previously described.

Once symptoms have been described by a patient in sufficient detail, a system in accordance with principles of inventive concepts may make a preliminary diagnosis (or a plurality of preliminary diagnoses) and provide the patient with information related to the diagnosis(es). FIG. 17E illustrates an informational display such as may be presented in an example embodiment. In this example embodiment, the patient's symptoms indicate a degenerative disk disease and a video 1720 on the topic is offered to the patient for viewing. Other informational displays, such as articles and links to other articles are contemplated within the scope of inventive concepts. Additionally, link 1722 takes a patient to a search feature that allows a patient to search for a physician who deals with the diagnosed condition. If the patient opts to search for a physician, the results of such a search may be displayed as in FIG. 17F, in which a brief description 1724 of one or more qualifying physicians are presented. In exemplary embodiments a map 1726 may also be displayed. With each brief description of a qualifying physician, a “view profile” link may allow a patient to view the profile of the physician. The profile may be, for example, as described in greater detail in the discussion related to FIG. 16.

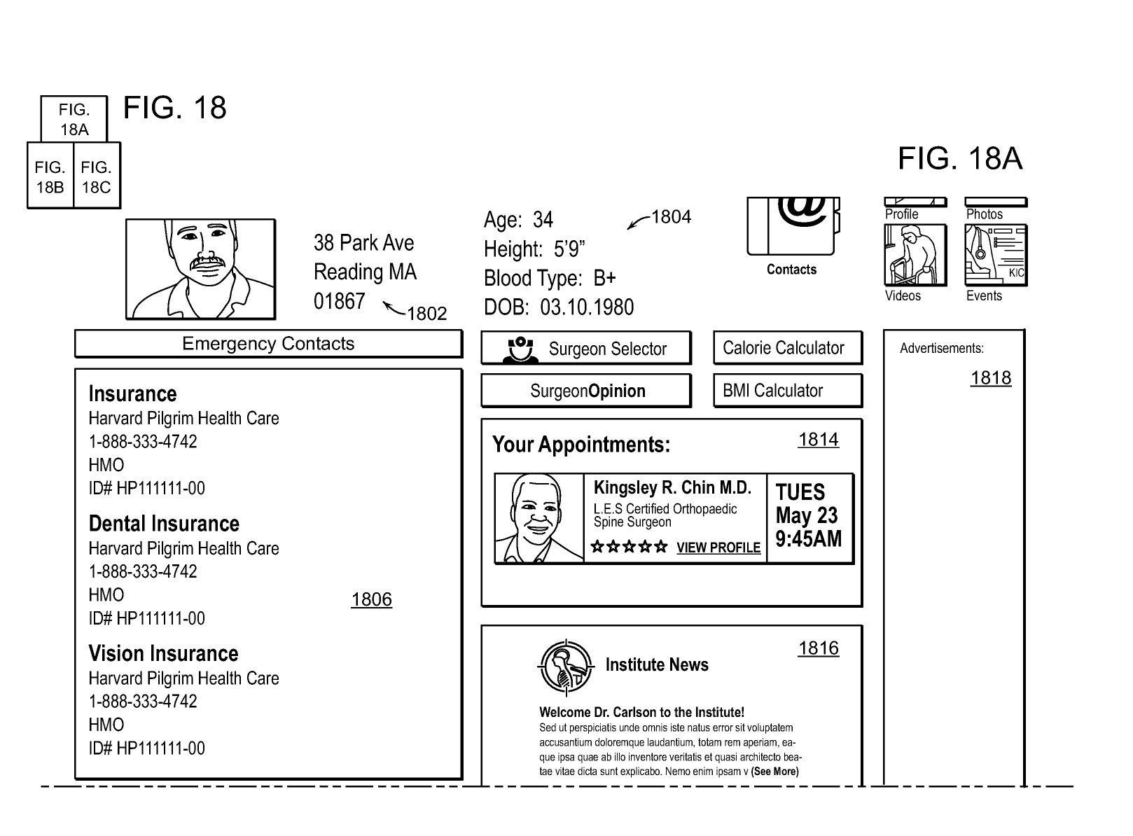

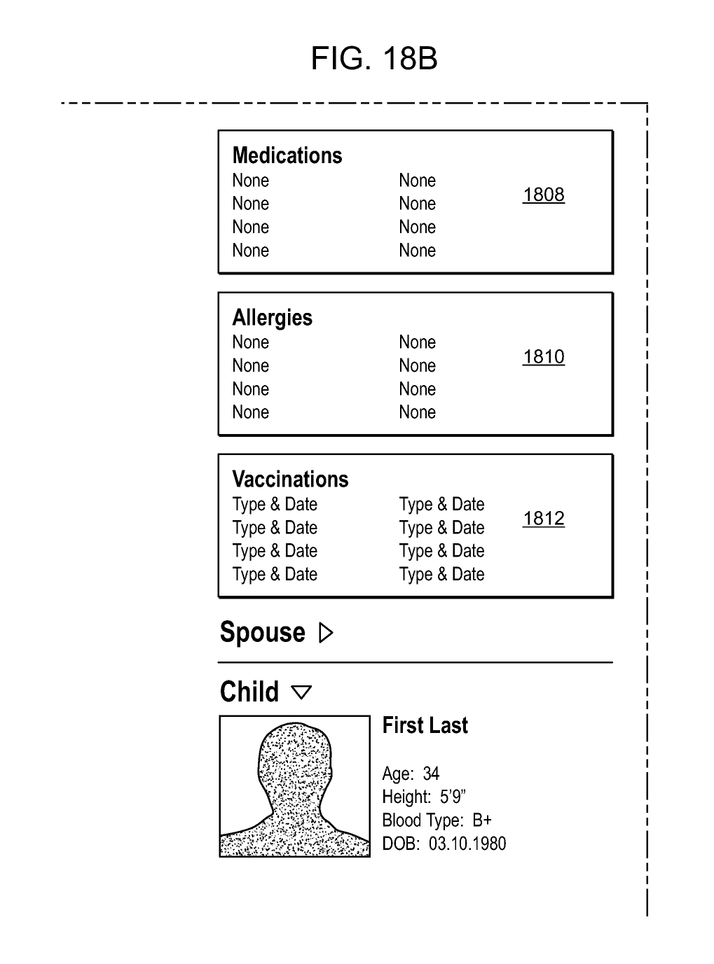

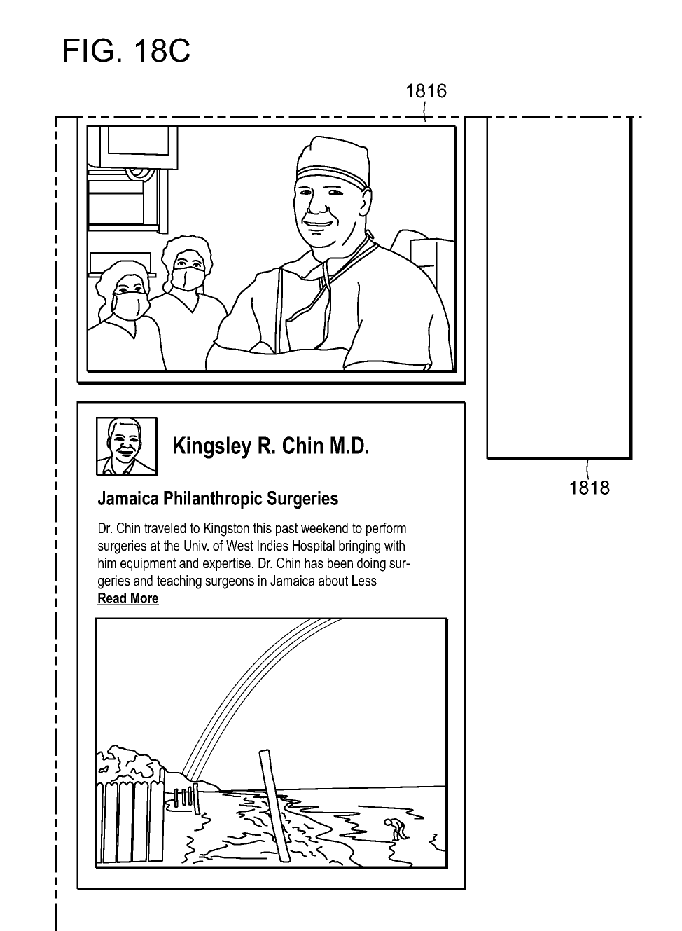

Much as a physician has a profile page a system in accordance with principles of inventive concepts, each patient may also be provided with a profile page, as illustrated in the exemplary screen shot of FIG. 18. A patient's profile page may include a region for an identifying photograph and address 1802 and basic physical description 1804, including, for example, date of birth, blood type, height and age. Insurance information may be presented in box 1806, a list of medications in box 1808, allergies in box 1810 and vaccinations in box 1812. Scheduled physician appointments may be listed in box 1814. Other areas may present health-related news 1816, which may be particularly directed at the patient, based upon his condition, symptoms, profile, or past interaction with a particular physician or group of physicians. Advertising 1818, particularly advertising related to medical services or supplies may also be presented to a patient on his profile page.

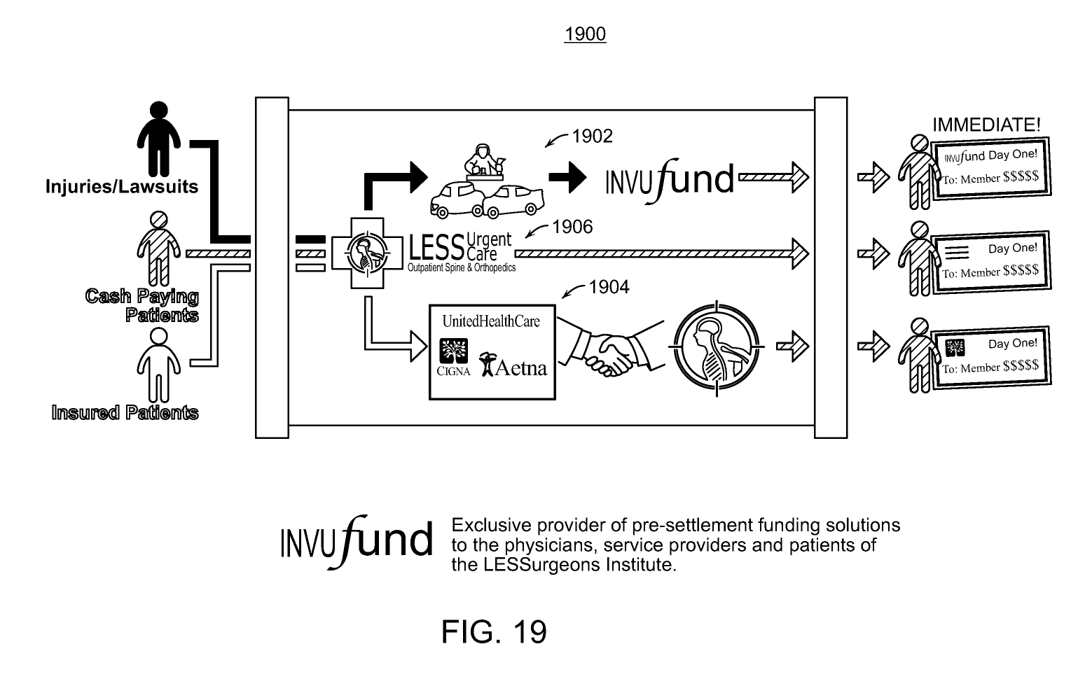

FIG. 19 illustrates a general payment flow from patient to system 1900 to physician, in accordance with principles of inventive concepts. For payment purposes patients may be categorized as insured patients, cash paying patients, or patients awaiting payment from an expected settlement due to lawsuits, for example. In an example embodiment, system 1900 in accordance with principles of inventive concepts provides pre-settlement funding 1902 to physicians associated with the system 1900 for patients that fall into the category of patients awaiting settlements. The system 1900 may also work with conventional insurance companies 1904 to provide a payment system for physicians, wherein the system 1900 handles the drudgery, complexity, and overhead of billing and collecting from conventional insurance companies. The system 1900 also provides urgent care facilities 1906 for patients requiring care that may be handled outside a hospital setting. Such facilities 1906 may dispense medicines and treatment, such as may be administered by nurse practitioners or physicians assistants, for example. In exemplary embodiments, a system in accordance with principles of inventive concepts may establish and manage urgent care facilities, which may be standalone facilities or may be operated in cooperation with a drug store, for example.

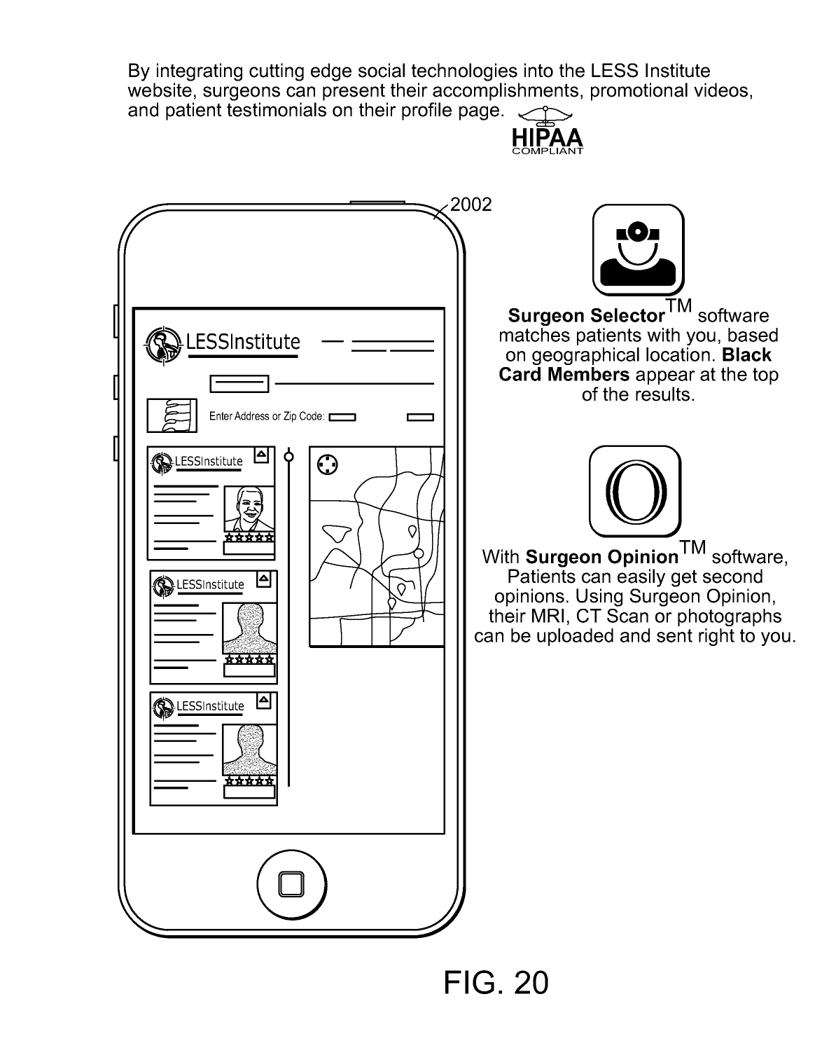

As indicated by the illustration of FIG. 20, services of a system in accordance with principles of inventive concepts may be available on a portable electronic device 2002, such as a smartphone, a tablet computer, or a laptop computer, for example. A system in accordance with principles of inventive concepts provides features of social networking, medical advice, physician locator, diagnostician, and medical information website. The system provides a marketing platform for physicians, provides for payment of physicians, and operates urgent care facilities, again matching patient and physician, operating facilities and handling payment for facilities. In some embodiments pre-settlement payment to physicians is also provided. Other outpatient facilities, including ambulatory surgical centers may be operated by a system in accordance with principles of inventive concepts. Outpatient care facilities may include rehabilitation facilities, including sports rehabilitation facilities, urgent care facilities, and pain management facilities, for example. A patient may obtain second opinions directly through the system.

A system in accordance with principles of inventive concepts may provide a physician with subscription options, which may entitle the physician to be assigned different levels of search priority when a patient conducts a search for a physician. A “Black” level physician is assigned highest listing priority, i.e., is listed first in online search results; platinum level physicians are given second listing priority and gold level physicians are given third listing priority. From the patient's perspective, concierge service provided through the system eliminates paperwork (every bit of information, once filled for one physician, may be used to populate all forms for all physicians, laboratories, and clinics within the system), eliminating or significantly reducing sign-in or wait times. Concierge service may also provide a patient with twenty-four hour access to his physician's office, same-day or next day appointment scheduling, online access to medical records, personalized wellness plans, family plans and referral systems, for example.

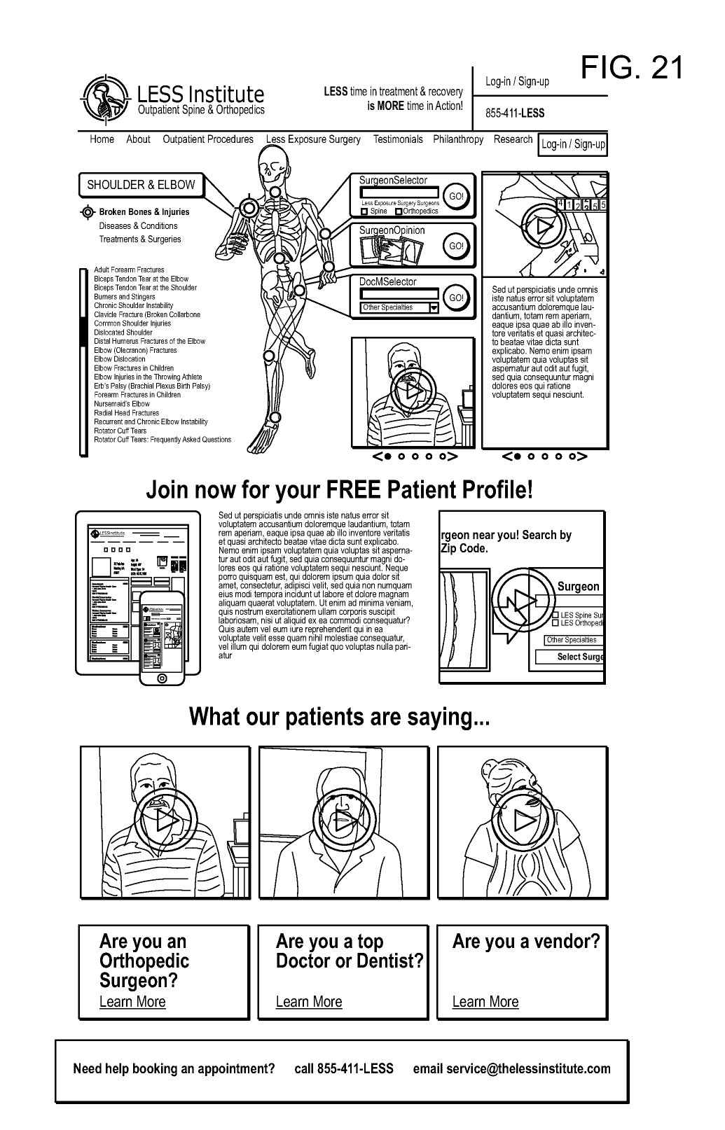

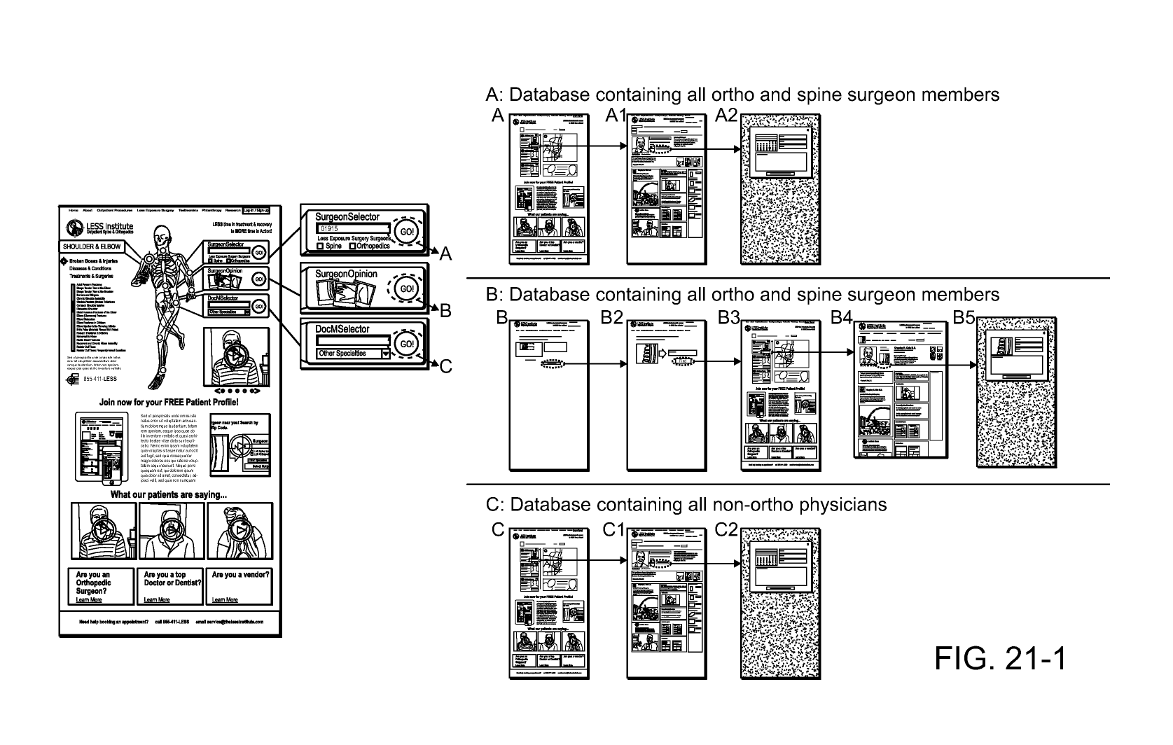

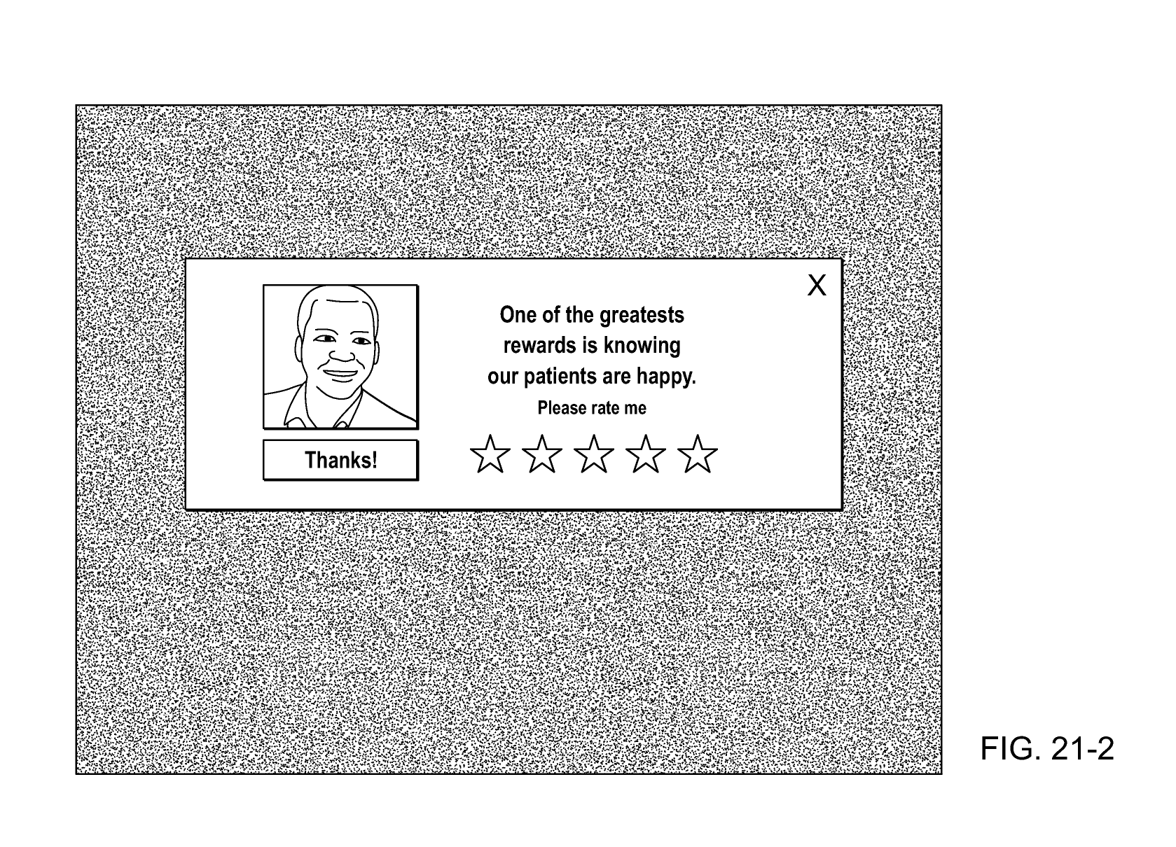

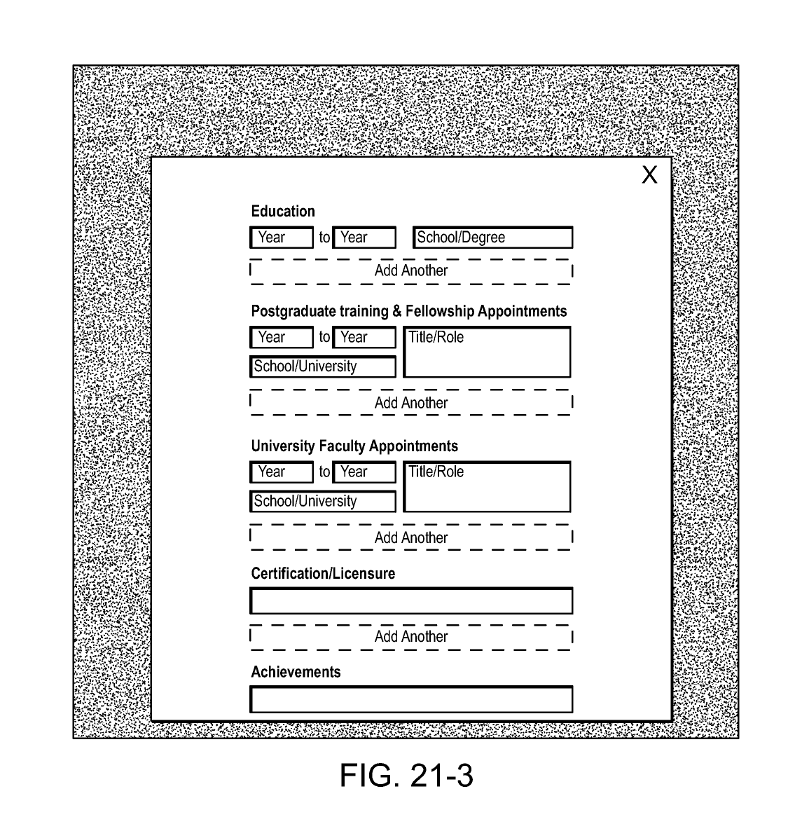

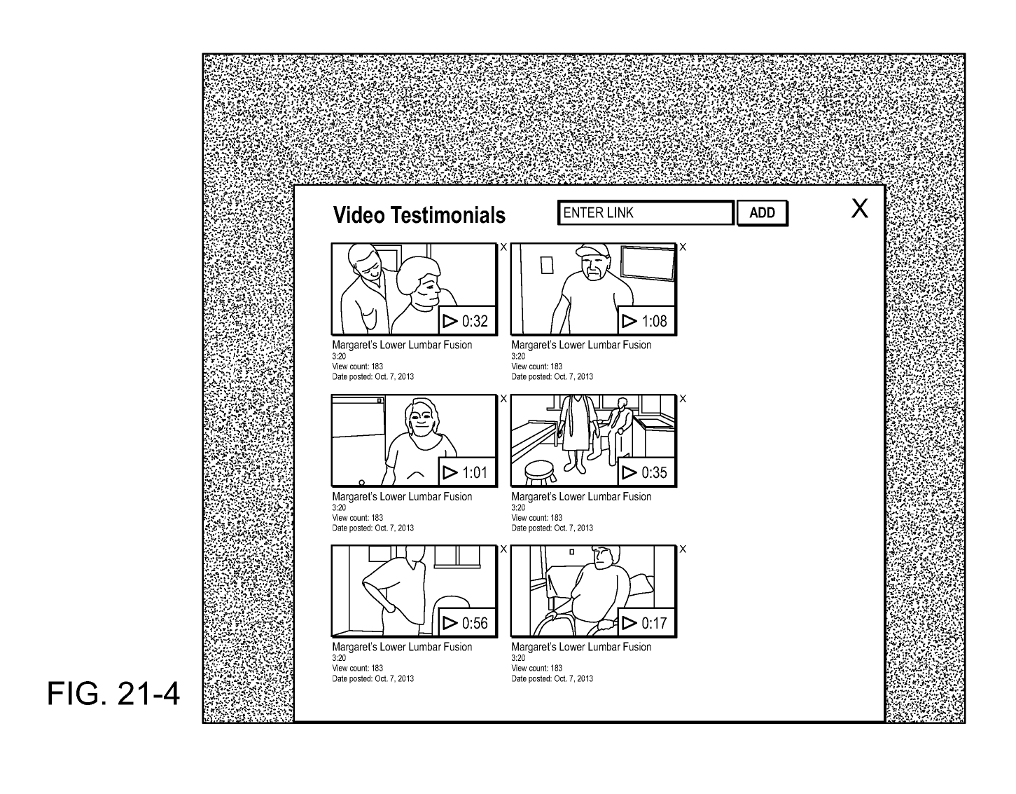

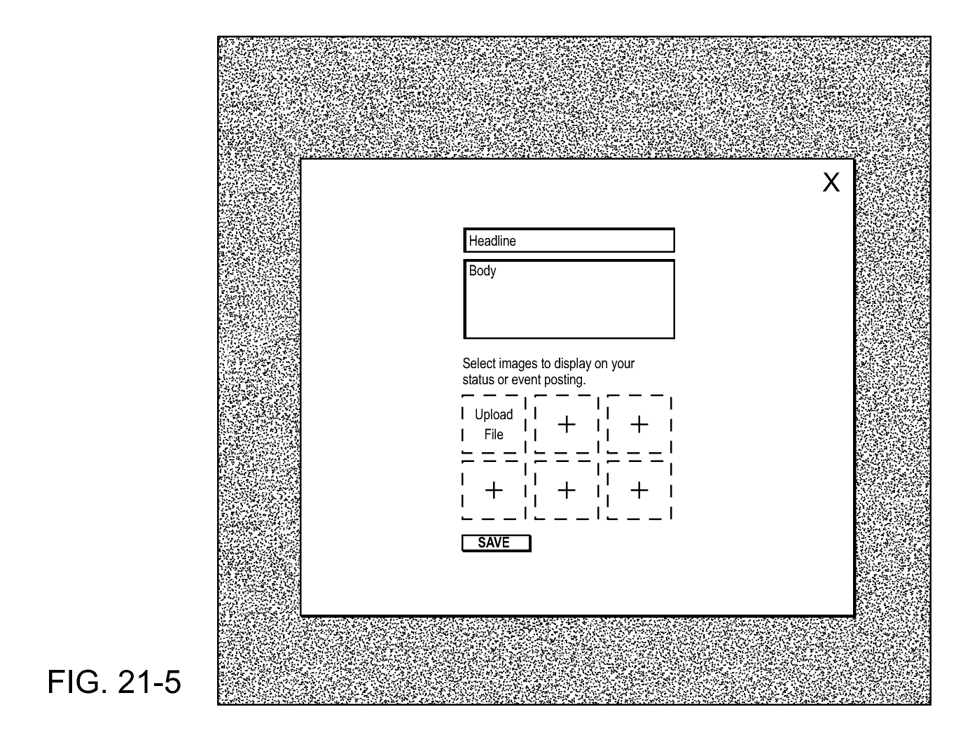

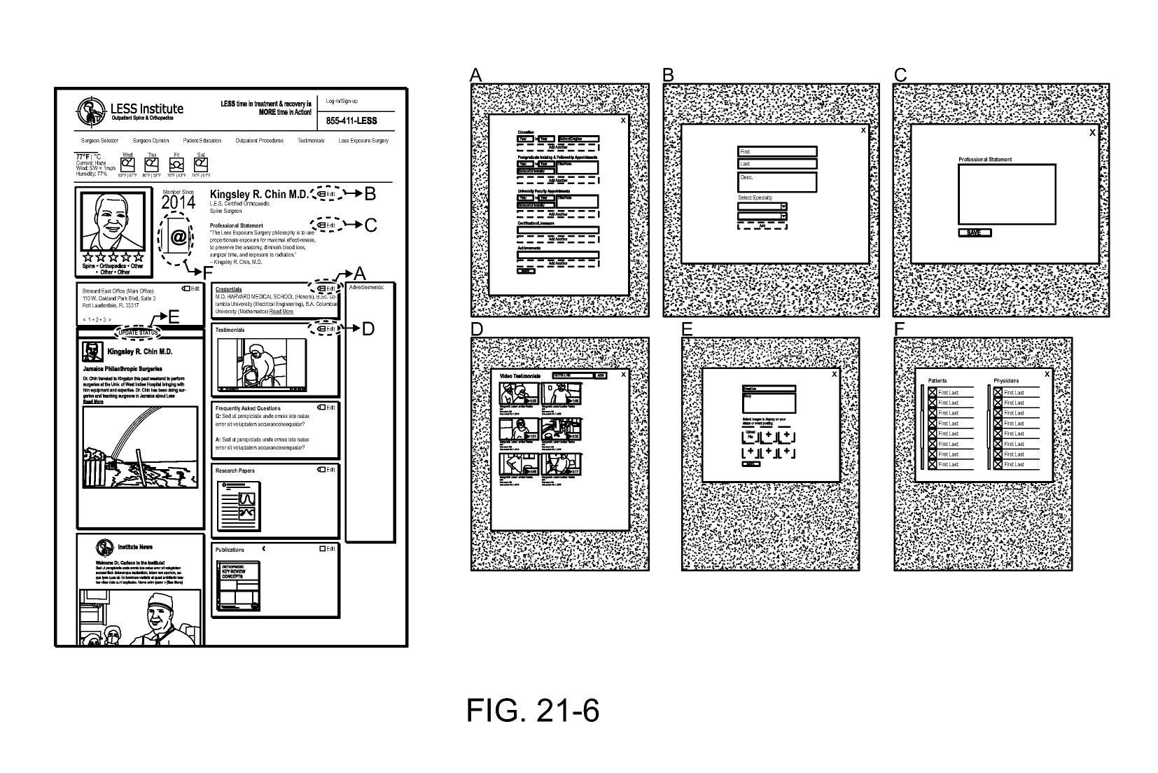

The illustrations in FIG. 21 are examples of user interfaces used by physicians or patients for some of the embodiments described herein.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

1. A service-oriented, integrative networking platform and system, comprising:
at least one processor and computer data storage system coupled together and accessible over at least on computer network; and
a set of modules comprising computer program code executable by the at least one processor to perform a set of medical networking functions, said functions including:
establishing an electronic community of user accounts, including consumer-user accounts and services and goods provider-user accounts, wherein the services and goods provider accounts includes medical professionals users, and
for each account in the electronic community, establishing at least one user profile, wherein for a specific user, a plurality of profiles can be generated and each profile can have a different set of content, connections, and/or user profile information; and
electronically displaying on at least one computer screen a service-oriented, integrative networking interface enabling user interaction with the electronic community via the user's account and set of profiles.

2. The system of claim 1, wherein the functions include displaying such profiles on a computer screen in a user-selectable tabbed form.

3. The system of claim 1, wherein each tab is color coded differently.

4. (canceled)

5. The system of claim 1, wherein said functions include a medical records transfer function that enable a transfer of medical records between a patient user and a medical professional user that are connected, through the system.

6. The system of claim 1, wherein said functions include:
pre-storing in a user account/profile login information for one or more 3^{rd} party systems; and
enabling a user to automatically login in to at least one of the one or more 3^{rd} party systems service-oriented, integrative networking interface without input of 3^{rd} party system login information.

7. The system of claim 1, wherein said functions include appointment and calendar functions, that enable a user to make appointment with a 3^{rd} party system of a services and goods provider professional account, and reflect such appointment, with reminders, in a user calendar.

8. The system of claim 1, wherein said functions include a referral function enabling a user to refer a services or goods provider to another connection.

9. The system of claim 1, wherein said functions include a recommendation function enabling a user to recommend a services or goods provider.

10. The system of claim 1, wherein said functions include a research function enabling a user to research services or goods providers based on a set of user specified criteria.

11. The system of claim 1, wherein said functions include an ecommerce function enabling a user to acquire services and goods from member services or goods providers.

12. The system of claim 1, wherein said functions include an ad manager function that directs advertisements to users, based on user information.

13. The system of claim 1, wherein such user information includes at least one of medical information; profile information; calendar or timeline information; interest information; user system interaction history, and/or combinations thereof.

14. (canceled)

15. A service-oriented, integrative networking method, executable by at least one processor and computer data storage system coupled together and accessible over at least on computer network, the method comprising:
establishing an electronic community of user accounts, including consumer-user accounts and services and goods provider-user accounts, wherein the services and goods provider accounts include medical professional users, and
for each account in the electronic community, establishing for each account at least one user profile, wherein for a specific user, a plurality of profiles can be generated and each profile can have a different set of content, connections, and/or user profile information; and
electronically displaying on at least one computer screen a service-oriented, integrative networking interface enabling user interaction with the electronic community via the user's account and set of profiles.

16. The method of claim 15, including displaying such profiles on a computer screen in a user-selectable tabbed form.

17. The method of claim 15, including coloring coding each tab differently.

18. (canceled)

19. The method of claim 15, including transferring medical records between a patient user and a medical professional user that are connected.

20. The method of claim 15, including:
pre-storing in a user account/profile login information for one or more 3^{rd} party systems; and
enabling a user to automatically login in to at least one of the one or more 3^{rd} party systems service-oriented, integrative networking interface without input of 3^{rd} party system login information.

21. The method of claim 15, including:
enabling a user to make an appointment with a 3^{rd} party system, and
reflecting such appointment in a user calendar.

22. The method of claim 15, including:
providing a referral function enabling a user to refer a services or goods provider to another connection.

23. The method of claim 15, including:
providing a recommendation function enabling a user to recommend a services or goods provider.

24.-29. (canceled)
